(19) United States
(12) Patent Application Publication
(10) Pub. No.: US 2021/0101451 A1
(43) Pub. Date: Apr. 8, 2021

(54) REFRIGERATION CYCLE DEVICE

(71) Applicant: DENSO CORPORATION, Kariya-city (JP)

(72) Inventors: Hiroyuki KOBAYASHI, Kariya-city (JP); Satoshi ITO, Kariya-city (JP); Yuichi KAMI, Kariya-city (JP); Kengo SUGIMURA, Kariya-city (JP)

(21) Appl. No.: 17/125,387

(22) Filed: Dec. 17, 2020

Related U.S. Application Data
(63) Continuation of application No. PCT/JP2019/023461, filed on Jun. 13, 2019.

(30) Foreign Application Priority Data
Jun. 21, 2018 (JP) 2018-117742

(51) Int. Cl. B60H 1/32; F25B 49/02

(52) U.S. Cl. CPC B60H 1/3211; F25B 49/022; B60H 2001/3263; B60H 2001/3266; B60H 2001/3261; F25B 2600/2513

(57) ABSTRACT

A first evaporator cools air-conditioning air. A second evaporator cools an object. A first orifice unit and a second orifice unit are capable of changing a refrigerant amount of the first evaporator and the second evaporator, respectively. A control unit controls both the first orifice unit and the second orifice unit so that a temperature of the second evaporator approaches a target temperature. The control unit, in a first mode, performs control not to evaporate a refrigerant at the first evaporator and to evaporate the refrigerant at the second evaporator. The control unit, in a second mode, performs control to evaporate the refrigerant at both the first evaporator and the second evaporator. The control unit sets the target temperature in a first mode higher than that in a second mode.

### CROSS REFERENCE TO RELATED APPLICATIONS

The present application is a continuation application of International Patent Application No. PCT/JP2019/023461 filed on Jun. 13, 2019, which designated the U.S. and claims the benefit of priority from Japanese Patent Application No. 2018-117742 filed on Jun. 21, 2018, the entire disclosure of the above application is incorporated herein by reference.

### TECHNICAL FIELD

The present disclosure relates to a refrigeration cycle device including a plurality of evaporators.

### BACKGROUND

A vehicle refrigeration cycle device is capable of air-conditioning, heating, and dehumidifying and heating a vehicle compartment. In some case, the vehicle may have a battery which needs a temperature control, especially needs cooling. For example, hybrid vehicles or electric vehicles have a battery that supplies driving power and needs cooling. The vehicle refrigeration cycle device may cool the battery in addition to the above air-conditioning purpose. However, it is also necessary to save power to use the vehicle refrigeration cycle device in such a multiple purposes. In the above aspects, or in other aspects not mentioned, there is a need for further improvements in a rotary electric machine for an internal combustion engine and its stator.

### SUMMARY

The refrigeration cycle device according to one aspect of the present disclosure includes a compressor, a radiator, a first evaporator, a second evaporator, a first orifice unit, a second orifice unit, and a control unit.

The compressor compress and discharge a refrigerant. The radiator dissipates heat of the refrigerant discharged from the compressor. The first evaporator evaporates the refrigerant. The second evaporator absorbs heat from a thermal medium circulating between a heat absorb object or from a heat absorb object, and evaporates the refrigerant.

The first orifice unit can change a flow amount of the refrigerant flowing into the first evaporator. The second orifice unit can change a flow amount of the refrigerant flowing into the second evaporator. The control unit controls operation of the compressor and the second orifice unit so that a temperature related to a temperature of the second evaporator approaches a target temperature.

The control unit switches between a first mode and a second mode. In the first mode, the first orifice unit and the second orifice unit are controlled so that the refrigerant does not evaporate in the first evaporator and the refrigerant evaporates in the second evaporator. In the second mode, the first orifice unit and the second orifice unit are controlled so that the refrigerant evaporates in both the first evaporator and the second evaporator. The control unit sets the target temperature higher in the first mode than in the second mode.

According to this, since the target temperature is set higher in the first mode than in the second mode, the compressor is controlled so that the temperature of the second evaporator becomes higher. Therefore, a power consumption of the compressor can be reduced.

Since the second evaporator evaporates the refrigerant by absorbing heat from the thermal medium circulating between the heat absorb object or from the heat absorb object, even if the temperature of the second evaporator rises, it is possible to secure a cooling capacity of the thermal medium or the heat absorb object by securing a temperature difference between the refrigerant of the second evaporator and the thermal medium or the heat absorb object.

Since the target temperature in the second mode is set lower than that in the first mode, it is possible to suppress lowering of power consumption of the compressor (see FIG. 25 described later) which may be caused by using in a state where an heat exchange efficiency and a cycle balance are poor.

### BRIEF DESCRIPTION OF DRAWINGS

The disclosure is further described with reference to the accompanying drawings in which:

FIG. 1 is an overall configuration diagram of a vehicle air-conditioner of a first embodiment;

FIG. 2 is a block diagram showing an electric control unit of the vehicular air-conditioner according to the first embodiment;

FIG. 3 is a flowchart showing a part of control processing of an air-conditioning control program of the first embodiment;

FIG. 4 is a flowchart showing another part of the control processing of the air-conditioning control program of the first embodiment;

FIG. 5 is a control characteristic diagram for switching operation modes of the air-conditioning control program of the first embodiment;

FIG. 6 is a control characteristic diagram for switching the operation modes of the air-conditioning control program of the first embodiment;

FIG. 7 is a control characteristic diagram for switching the operation modes of the air-conditioning control program of the first embodiment;

FIG. 8 is a flowchart showing control processing of an air-conditioning mode of the first embodiment;

FIG. 9 is a flowchart showing control processing of a series dehumidifying and heating mode of the first embodiment;

FIG. 10 is a control characteristic diagram for determining an opening pattern of a heating expansion valve and an air-conditioning expansion valve in the series dehumidifying and heating mode of the first embodiment;

FIG. 11 is a flowchart showing control processing of a parallel dehumidifying and heating mode of the first embodiment;

FIG. 12 is a control characteristic diagram for determining an opening pattern of a heating expansion valve and an air-conditioning expansion valve in the parallel dehumidifying and heating mode of the first embodiment;

FIG. 13 is a flowchart showing control processing of a heating mode of the first embodiment;

FIG. 14 is a flowchart showing control processing of the air-conditioning and cooling mode of the first embodiment;

FIG. 15 is a flowchart showing control processing of a series dehumidifying and heating mode of the first embodiment;

FIG. 16 is a flowchart showing control processing of a series dehumidifying, heating, and cooling mode of the first embodiment;

FIG. 17 is a flowchart showing control processing of a heating and cooling mode of the first embodiment;

FIG. 18 is a flowchart showing control processing of a heating and series cooling mode of the first embodiment;

FIG. 19 is a control characteristic diagram for determining an opening pattern of a heating expansion valve and a cooling expansion valve in the heating and series cooling mode of the first embodiment;

FIG. 20 is a flowchart showing control processing of a heating and parallel cooling mode of the first embodiment;

FIG. 21 is a control characteristic diagram for determining an opening pattern of a heating expansion valve and a cooling expansion valve in the heating and parallel cooling mode of the first embodiment;

FIG. 22 is a flowchart showing control processing of a cooling mode of the first embodiment;

FIG. 23 is a graph showing a target low temperature side thermal medium temperature in each operation mode of the first embodiment;

FIG. 24 is a graph showing a relationship between a compressor rotation speed, a power consumption, and a target low temperature side thermal medium temperature in the heating and cooling mode and the cooling mode of the first embodiment;

FIG. 25 is a Mollier chart showing an operating state when the target low temperature side thermal medium temperature is set high in the air-conditioning and cooling mode of the first embodiment;

FIG. 26 is a Mollier chart showing an operating state when the target low temperature side thermal medium temperature is set high in the heating and series cooling mode of the first embodiment;

FIG. 27 is an overall configuration diagram of a vehicle air-conditioner of a second embodiment;

FIG. 28 is an overall configuration diagram of a vehicle air-conditioner of a third embodiment; and

FIG. 29 is an overall configuration diagram of a vehicle air-conditioner of a fourth embodiment.

### DETAILED DESCRIPTION

Hereinafter, embodiments for implementing the present disclosure will be described referring to drawings. In the respective embodiments, parts corresponding to matters already described in the preceding embodiments are given reference numbers identical to reference numbers of the matters already described. The same description is therefore omitted depending on circumstances. In a case where only a part of the configuration is described in each embodiment, the other embodiments described above can be applied to the other part of the configuration. The present disclosure is not limited to combinations of embodiments which combine parts that are explicitly described as being combinable. As long as no problem is present, the various embodiments may be partially combined with each other even if not explicitly described.

### First Embodiment

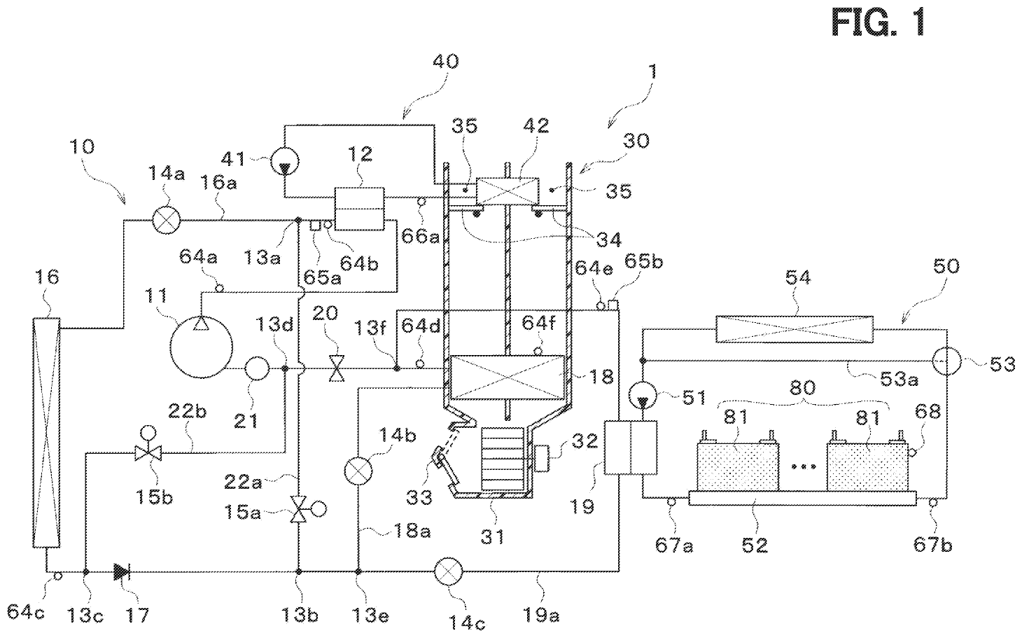

A first embodiment of the present disclosure will be described with reference to FIG. 1 to FIG. 26. In the present embodiment, a refrigeration cycle device 10 according to the present disclosure is applied to a vehicle air-conditioner 1 mounted on an electric vehicle that obtains a driving force for traveling from an electric motor. The vehicle air-conditioner 1 not only air-conditions the vehicle compartment, which is a space to be air-conditioned, but also adjusts a temperature of the battery 80. Therefore, the vehicle air-conditioner 1 can also be called an air-conditioner with a battery temperature adjusting function.

The battery 80 is a secondary battery that stores electric power supplied to in-vehicle devices such as an electric motor. The battery 80 of this embodiment is a lithium-ion battery. The battery 80 is a so-called an assembled battery formed by stacking a plurality of battery cells 81 and electrically connecting the battery cells 81 in series or in parallel.

The output of this type of battery tends to decrease when the temperature becomes low, and the deterioration thereof easily progresses when the temperature becomes high. Therefore, the temperature of the battery needs to be maintained within an appropriate temperature range (15° C. (Celsius degrees) or higher and 55° C. or lower in the present embodiment) in which the charge/discharge capacity of the battery can be fully utilized.

Therefore, the vehicle air-conditioner 1 is configured to be able to cool the battery 80 by a cold thermal energy generated by the refrigeration cycle device 10. Therefore, a cooling object different from a blown air in the refrigeration cycle device 10 of the present embodiment is the battery 80.

The vehicle air-conditioner 1 includes the refrigeration cycle device 10, an indoor air-conditioning unit 30, a high temperature side thermal medium circuit 40, a low temperature side thermal medium circuit 50, etc., as shown in the overall configuration diagram of FIG. 1.

The refrigeration cycle device 10 cools blown air that is blown into the vehicle compartment to air-condition the vehicle compartment. The refrigeration cycle device 10 heats the high temperature side thermal medium circulating in the high temperature side thermal medium circuit 40 in order to perform air-conditioning in the vehicle compartment. The refrigeration cycle device 10 cools a low temperature side thermal medium circulating in the low temperature side thermal medium circuit 50 in order to cool the battery 80.

The refrigeration cycle device 10 is configured to be able to switch refrigerant circuits for various operation modes in order to perform air-conditioning in the vehicle compartment. For example, a refrigerant circuit for a cooling mode, a refrigerant circuit for a dehumidifying and heating mode and a refrigerant circuit for a heating mode and the like are configured to be able to switch. Further, the refrigeration cycle apparatus 10 can switch, in each operation mode for air-conditioning, between an operation mode in which the battery 80 is cooled and an operation mode in which the battery 80 is not cooled.

Further, the refrigeration cycle device 10 uses an HFO-based refrigerant (specifically, R1234yf) as a refrigerant, and provides a vapor compression type subcritical refrigeration cycle in which a pressure of a discharged refrigerant discharged from the compressor 11 does not exceed the critical pressure of the refrigerant. Further, a refrigerator oil for lubricating the compressor 11 is mixed in the refrigerant. Part of the refrigerator oil circulates in the cycle together with the refrigerant.

Among components of the refrigeration cycle device 10, the compressor 11 draws in, compresses, and discharges the refrigerant in the refrigeration cycle device 10. The compressor 11 is arranged in a front of the vehicle compartment and is arranged in a drive device compartment that accommodates an electric motor and the like. The compressor 11 is an electric compressor that rotationally drives a fixed capacity type compression mechanism having a fixed discharge capacity by an electric motor. The rotation speed (that is, refrigerant discharge capacity) of the compressor 11 is controlled by a control signal output from a control unit 60 described later.

An inlet of a refrigerant passage of a water-refrigerant heat exchanger 12 is connected to a discharge port of the compressor 11. The water-refrigerant heat exchanger 12 has a refrigerant passage through which the high-pressure refrigerant discharged from the compressor 11 flows and a water passage through which the high-temperature side thermal medium circulating in the high-temperature side thermal medium circuit 40 flows. The water-refrigerant heat exchanger 12 is a heating heat exchanger to heat the high temperature side thermal medium, by performing heat exchange between the high pressure refrigerant flowing through the refrigerant passage and the high temperature side thermal medium flowing through the water passage. The water-refrigerant heat exchanger 12 is a radiator that dissipates heat from the refrigerant discharged from the compressor 11.

An inlet side of a first three-way joint 13a having three inlets and outlets is connected to an outlet of the refrigerant passage of the water-refrigerant heat exchanger 12. A joint formed by jointing a plurality of pipes, or a joint formed by providing a plurality of refrigerant passages to a metal block or a resin brock may be utilized as a this kind of the three-way joint.

Further, the refrigeration cycle apparatus 10 includes a second three-way joint 13b to a sixth three-way joint 13f, as will be described later. The basic configuration of each of the second to sixth three-way joints 13b to 13f is similar to that of the first three-way joint 13a.

An inlet side of a heating expansion valve 14a is connected to one outlet of the first three-way joint 13a. One of the inlets of the second three-way joint 13b is connected to the other outlet of the first three-way joint 13a via a bypass passage 22a. A dehumidifying on-off valve 15a is arranged in the bypass passage 22a.

The dehumidifying on-off valve 15a is an electromagnetic valve that opens or closes the refrigerant passage connecting the other outlet of the first three-way joint 13a and the one inlet of the second three-way joint 13b. The dehumidifying on-off valve 15a is a bypass on-off unit that opens or closes the bypass passage 22a.

Further, the refrigeration cycle device 10 includes a heating on-off valve 15b, as described later. The basic configuration of the heating on-off valve 15b is the same as that of the dehumidifying on-off valve 15a.

The dehumidifying on-off valve 15a and the heating on-off valve 15b can switch the refrigerant circuit of each of the operation modes by opening or closing the refrigerant passage. Therefore, the dehumidifying on-off valve 15a and the heating on-off valve 15b are refrigerant circuit switching devices for switching the refrigerant circuit of the cycle. Operations of the dehumidifying on-off valve 15a and the heating on-off valve 15b are controlled by control voltages output from the control unit 60.

The heating expansion valve 14a is a heating pressure reducer, which decompresses the high-pressure refrigerant flowing out of the refrigerant passage of the water-refrigerant heat exchanger 12, and simultaneously adjusts a flow amount (mass flow rate) of the refrigerant flowing out to a downstream side, in an operation mode for heating at least the vehicle compartment. The heating expansion valve 14a is an electric variable orifice mechanism that includes a valve element, which is changeable in degree of orifice, and an electric actuator, which changes a degree of opening of the valve element.

Further, the refrigeration cycle device 10 includes an air-conditioning expansion valve 14b and a cooling expansion valve 14c, as described later. The basic configurations of the air-conditioning expansion valve 14b and the cooling expansion valve 14c are similar to those of the heating expansion valve 14a.

The heating expansion valve 14a, the air-conditioning expansion valve 14b, and the cooling expansion valve 14c have a fully open function and a fully closed function. The fully open function is a function of simply opening the valve opening to provide a simple refrigerant passage with almost no flow amount adjusting action and refrigerant reducing action. The fully closed function is a function of closing the refrigerant passage by fully closing the valve opening.

The heating expansion valve 14a, the air-conditioning expansion valve 14b, and the cooling expansion valve 14c can switch the refrigerant circuit in each operation mode by the fully open function and the fully closed function.

Therefore, the heating expansion valve 14a, the air-conditioning expansion valve 14b, and the cooling expansion valve 14c of the present embodiment also have a function as a refrigerant circuit switching device. The operations of the heating expansion valve 14a, the air-conditioning expansion valve 14b, and the cooling expansion valve 14c are controlled by control signals (control pulse) output from the control unit 60.

The heating expansion valve 14a is an orifice unit for the outdoor heat exchanger capable of changing a flow amount of the refrigerant flowing into the outdoor heat exchanger 16. The air-conditioning expansion valve 14b is an indoor evaporator orifice unit capable of changing a flow amount of the refrigerant flowing into the indoor evaporator 18.

The heating expansion valve 14a and the air-conditioning expansion valve 14b are a first orifice unit capable of changing the flow amount of the refrigerant flowing into the outdoor heat exchanger 16 and the indoor evaporator 18. The cooling expansion valve 14c is a second orifice unit capable of changing the flow amount of the refrigerant flowing into the chiller 19.

A refrigerant inlet side of the outdoor heat exchanger 16 is connected to an outlet of the heating expansion valve 14a. The outdoor heat exchanger 16 is a heat exchanger for exchanging heat between the refrigerant flowing out from the heating expansion valve 14a and the outside air blown by a cooling fan (not shown). The outdoor heat exchanger 16 is arranged on the front side within an inside of the drive device chamber. Therefore, traveling wind can be applied to the outdoor heat exchanger 16 when the vehicle is traveling.

The outdoor heat exchanger 16 is a radiator to dissipate heat from the refrigerant. The outdoor heat exchanger 16 is also a first evaporator to evaporate the refrigerant.

The first refrigerant passage 16a is a refrigerant passage to guide the refrigerant flowing out of the water-refrigerant heat exchanger 12 to the inlet side of the outdoor heat exchanger 16.

An inlet of the third three-way joint 13c is connected to the refrigerant outlet of the outdoor heat exchanger 16. One inlet of the fourth three-way joint 13d is connected to one outlet of the third three-way joint 13c via the heating passage 22b.

The heating passage 22b is a second refrigerant passage to guide the refrigerant flowing out of the outdoor heat exchanger 16 to the suction side of the compressor 11. The heating on-off valve 15b for opening and closing the refrigerant passage is arranged in the heating passage 22b. The heating on-off valve 15b is a second refrigerant passage on-off unit that opens or closes the second refrigerant passage.

Another inlet of the second three-way joint 13b is connected to another outlet of the third three-way joint 13c. A check valve 17 is disposed in a refrigerant passage connecting the other outlet of the third three-way joint 13c and the other inlet of the second three-way joint 13b. The check valve 17 allows the refrigerant to flow from the third three-way joint 13c side to the second three-way joint 13b side, and prohibits the refrigerant from flowing from the second three-way joint 13b side to the third three-way joint 13c side.

An inlet of the fifth three-way joint 13e is connected to an outlet of the second three-way joint 13b. An inlet of the cooling expansion valve 14b is connected to one outlet of the fifth three-way joint 13e. An inlet of the cooling expansion valve 14c is connected to an other outlet of the fifth three-way joint 13e.

The cooling expansion valve 14b is a heating pressure reducer, which decompresses the refrigerant flowing out from the outdoor heat exchanger 16, and simultaneously adjusts the flow amount of the refrigerant flowing out to the downstream side, in an operation mode for cooling at least the vehicle compartment.

A refrigerant inlet side of the indoor evaporator 18 is connected to an outlet side of the air-conditioning expansion valve 14b. The indoor evaporator 18 is disposed in the air-conditioning case 31 of the indoor air-conditioning unit 30 described later. The indoor evaporator 18 is a cooling heat exchanger to cool the blown air by making the low-pressure refrigerant to absorb heat by evaporating the low-pressure refrigerant, by performing heat exchange between the low pressure refrigerant decompressed by the air-conditioning expansion valve 14b and the blown air supplied from the blower 32. Another inlet of the sixth three-way joint 13f is connected to a refrigerant outlet of the indoor evaporator 18.

The cooling expansion valve 14c is a cooling pressure reducer, which decompresses the refrigerant flowing out of the outdoor heat exchanger 16, and simultaneously adjusts a flow amount of the refrigerant flowing out to the downstream side, in at least an operation mode in which at least the battery 80 is cooled.

The inlet side of the refrigerant passage of the chiller 19 is connected to the outlet of the cooling expansion valve 14c. The chiller 19 has a refrigerant passage through which a low-pressure refrigerant whose pressure has been reduced by the cooling expansion valve 14c flows, and a water passage through which a low-temperature side thermal medium circulating in the low-temperature side thermal medium circuit 50 flows. The chiller 19 is a second evaporator to make the low-pressure refrigerant to evaporate and to absorb heat, by performing heat exchanging between the low-pressure refrigerant flowing through the refrigerant passage and the low-temperature side thermal medium flowing through the water passage. Another inlet of the sixth three-way joint 13f is connected to an outlet of the refrigerant passage of the chiller 19.

An inlet of the evaporation pressure regulating valve 20 is connected to an outlet of the sixth three-way joint 13f. The evaporation pressure regulating valve 20 keeps a refrigerant evaporating pressure in the indoor evaporator 18 above or at a predetermined reference pressure in order to prevent frost formation on the indoor evaporator 18. The evaporation pressure regulating valve 20 is configured with a mechanical variable orifice mechanism that increases a degree of valve opening as a pressure of the refrigerant on the outlet side of the indoor evaporator 18 increases.

As a result, the evaporation pressure regulating valve 20 maintains the refrigerant evaporation temperature in the indoor evaporator 18 at or above the frost suppression temperature (1° C. in the present embodiment) capable of suppressing frost formation on the indoor evaporator 18. Further, the evaporation pressure regulating valve 20 of the present embodiment is arranged on a downstream side of the sixth three-way joint 13f, which is a merging portion.

Therefore, the evaporation pressure regulating valve 20 also maintains the refrigerant evaporation temperature in the chiller 19 at the frost formation suppression temperature or higher.

Another inlet of the fourth three-way joint 13d is connected to an outlet of the evaporation pressure regulating valve 20. An inlet side of the accumulator 21 is connected to an outlet of the fourth three-way joint 13d. The accumulator 21 is a gas-liquid separator that separates gas and liquid of the refrigerant flowing into the accumulator 21 and stores therein surplus liquid-phase refrigerant of the cycle. A gas-phase refrigerant outlet of the accumulator 21 is connected to a suction port side of the compressor 11.

The third refrigerant passage 18a is a refrigerant passage that guides the refrigerant flowing out of the outdoor heat exchanger 16 to the suction side of the compressor 11 via the evaporator 18.

The battery cooling passage 19a is a refrigerant passage to guide the refrigerant flowing between the outdoor heat exchanger 16 and the air-conditioning expansion valve 14b to between the indoor evaporator 18 in the third refrigerant passage 18a and the suction side of the compressor 11 via the chiller 19.

As is clear from the above description, the fifth three-way joint 13e of the present embodiment functions as a branch portion that branches the refrigerant flow that has flowed out of the outdoor heat exchanger 16. The sixth three-way joint 13f is a merging portion, which merges a refrigerant flow flowing out of the indoor evaporator 18 and the refrigerant flow flowing out of the chiller 19 and discharges it to a suction side of the compressor 11.

Then, the indoor evaporator 18 and the chiller 19 are connected to each other in parallel with the refrigerant flow. Further, the bypass passage 22a guides the refrigerant flowing out of the refrigerant passage of the water-refrigerant heat exchanger 12 to the upstream side of the branch portion. The heating passage 22b guides the refrigerant flowing out of the outdoor heat exchanger 16 to the suction port side of the compressor 11.

Next, the high temperature side thermal medium circuit 40 will be described. The high temperature side thermal medium circuit 40 is a thermal medium circulation circuit for circulating the high temperature side thermal medium. As the high temperature side thermal medium, ethylene glycol, dimethylpolysiloxane, a solution including a nano-fluid or the like, an antifreeze liquid or the like can be adopted. In the high temperature side thermal medium circuit 40, a water passage of a water-refrigerant heat exchanger 12, a high temperature side thermal medium pump 41, and a heater core 42, etc. are arranged.

The high temperature side thermal medium pump 41 is a water pump that pumps the high temperature side thermal medium to the inlet side of the water passage of the water-refrigerant heat exchanger 12. The high-temperature side thermal medium pump 41 is an electric pump in which a rotation speed (that is, a pumping capacity) is controlled by a control voltage output from the control unit 60.

Further, a thermal medium inlet side of the heater core 42 is connected to an outlet of the water passage of the water-refrigerant heat exchanger 12. The heater core 42 is a heat exchanger to heat the blown air by performing heat exchange between the high-temperature side thermal medium heated by the water-refrigerant heat exchanger 12 and the blown air passed through the indoor evaporator 18. The heater core 42 is arranged in the air-conditioning case 31 of the indoor air-conditioning unit 30. A suction port side of the high temperature side thermal medium pump 41 is connected to a thermal medium outlet of the heater core 42.

Therefore, in the high temperature side thermal medium circuit 40, it is possible to adjust a heat dissipation amount from the high temperature side thermal medium to the blown air at the heater core 42 by adjusting a flow amount of the high temperature side thermal medium flowing into the heater core 42 by the high temperature side thermal medium pump 41. Therefore, in the high temperature side thermal medium circuit 40, the high temperature side thermal medium pump 41 can adjust a heating amount of the blown air at the heater core 42 by adjusting the flow amount of the high temperature side thermal medium flowing into the heater core 42.

That is, in the present embodiment, each of the components of the water-refrigerant heat exchanger 12 and the high temperature side thermal medium circuit 40 constitutes a heating unit for heating the blown air using the refrigerant discharged from the compressor 11 as a heat source.

Next, the low temperature side thermal medium circuit 50 will be described. The low temperature side thermal medium circuit 50 is a thermal medium circulation circuit for circulating the low temperature side thermal medium. As the low temperature side thermal medium, the same fluid as the high temperature side thermal medium can be adopted. In the low temperature side thermal medium circuit 50, a water passage of the chiller 19, a low temperature side thermal medium pump 51, a cooling heat exchange unit 52, a three-way valve 53, a low temperature side radiator 54 and the like are arranged.

The low temperature side thermal medium pump 51 is a water pump that pumps the low temperature side thermal medium to the inlet side of the water passage of the chiller 19. The basic configuration of the low temperature side thermal medium pump 51 is the same as that of the high temperature side thermal medium pump 41.

The inlet side of the cooling heat exchange unit 52 is connected to the outlet of the water passage of the chiller 19. The cooling heat exchange unit 52 has a plurality of metal thermal medium flow paths arranged so as to come into contact with a plurality of battery cells 81 (in other words, heat absorb objects) forming the battery 80. In addition, it is a heat exchange unit to cool the battery 80 by performing heat exchange between the low temperature side thermal medium flowing through the thermal medium flow path and the battery cells 81.

Such a cooling heat exchange unit 52 may be formed by disposing a thermal medium passage between the battery cells 81 arranged in a stacking manner. The cooling heat exchange unit 52 may be formed integrally with the battery 80. For example, it may be integrally formed with the battery 80 by arranging the a thermal medium passage to a dedicated case for accommodating the battery cells 81 arranged in a stacking manner.

The inlet of the three-way valve 53 is connected to the outlet of the cooling heat exchange unit 52. The three-way valve 53 is an electric three-way flow rate adjusting valve that has one inlet and two outlets and is capable of continuously adjusting the passage area ratio of the two outlets. Operation of the three-way valve 53 is controlled by a control signal output from the control unit 60.

The thermal medium inlet side of the low temperature side radiator 54 is connected to one outlet of the three-way valve 53. The suction port side of the low temperature side thermal medium pump 51 is connected to the other outlet of the three-way valve 53 via a radiator bypass flow path 53a.

The radiator bypass flow path 53a is a thermal medium flow path through which the low temperature side thermal medium flowing out of the cooling heat exchange unit 52 flow the low temperature side radiator 54 in a bypassing manner. Therefore, in the low temperature side thermal medium circuit 50, the three-way valve 53 continuously adjusts a flow amount of the low temperature side thermal medium flowing into the low temperature side radiator 54 among the low temperature side thermal medium flowing out from the cooling heat exchange unit 52.

The low temperature side radiator 54 is a heat exchanger to dissipates heat of the low temperature side thermal medium to the outside air, by performing heat exchange between the low temperature side thermal medium flowing out from the cooling heat exchange unit 52 and the outside air blown by an outside air fan (not shown).

The low temperature side radiator 54 is arrange on the front side within the drive device compartment. Therefore, the traveling wind can be applied to the low temperature side radiator 54 when the vehicle is traveling. Therefore, the low temperature side radiator 54 may be integrally formed with the outdoor heat exchanger 16 and the like. The suction port side of the low temperature side thermal medium pump 51 is connected to the thermal medium outlet of the low temperature side radiator 54.

Therefore, in the low temperature side thermal medium circuit 50, the low temperature side thermal medium pump 51 can adjust an amount of heat absorbed from the battery 80 to the low temperature side thermal medium in the cooling heat exchange unit 52 by adjusting a flow amount of the low temperature side thermal medium flowing into the cooling heat exchange unit 52. That is, in the present embodiment, the components of the chiller 19 and the low-temperature side thermal medium circuit 50 configure a cooling unit to cool the battery 80, by evaporating the refrigerant flowing out from the cooling expansion valve 14c.

Next, the indoor air-conditioning unit 30 will be described. The indoor air-conditioning unit 30 is configured to blow the blown air that is temperature-conditioned by the refrigeration cycle device 10 into the vehicle compartment.

The indoor air-conditioning unit 30 is disposed inside an instrument panel at the foremost part of the vehicle compartment.

As shown in FIG. 1, the indoor air-conditioning unit 30 accommodates a blower 32, the indoor evaporator 18, and the heater core 42, within an air passage formed within the air-conditioning case 31 forming an outer shell of the indoor air-conditioning unit 30.

The air-conditioning case 31 forms an air passage for the blown air blown to the vehicle compartment. The air-conditioning case 31 is formed of a resin (for example, polypropylene) having a certain degree of elasticity and also excellent in strength.

An inside-outside air switching device 33 is disposed on the blown air flow most upstream side of the air-conditioning case 31. The inside-outside air switch device 33 switches and introduces an inside air (air within the vehicle compartment) and an outside air (air outside the vehicle compartment) into the air-conditioning case 31.

The inside-outside air switch device 33 changes an introduction ratio between an introduction air volume of the inside air and an introduction air volume of the outside air by continuously adjusting opening areas of the inside air introduction port through which the inside air is introduced and of an outside air introduction port through which the outside air is introduced into the air-conditioning case 31 by using an inside-outside air switch door. The inside-outside air switch door is driven by an electric actuator for the inside-outside air switch door. Operation of the electric actuator is controlled in accordance with a control signal output from the control unit 60.

The blower 32 is disposed downstream of the inside-outside air switch device 33 in flow of the blown air. The blower 32 blows air sucked through the inside-outside air switch device 33 toward the inside of the vehicle compartment. The blower 32 is an electric blower in which a centrifugal multi-blade fan is driven by an electric motor. A rotation speed (that is, an air blowing capacity) of the blower 32 is controlled by a control voltage output from the control unit 60.

The indoor evaporator 18 and the heater core 42 are disposed in this order downstream of the blower 32 in flow of the blown air. That is, the indoor evaporator 18 is disposed on a blown air flow upstream of the heater core 42.

In the air-conditioning case 31, a cold air bypass passage 35 is provided in which the blown air passed through the indoor evaporator 18 is caused to flow around the heater core 42. An air-mix door 34 is disposed in the air-conditioning case 31 at the blown air flow downstream side of the indoor evaporator 18 and at the blown air flow upstream side of the heater core 42.

The air-mix door 34 is an air volume ratio adjusting unit which controls an air volume ratio of a volume of the blown air passing through the heater core 42 to a volume of the blown air passing through the cold air bypass passage 35 after passing through the indoor evaporator 18. The air-mix door 34 is driven by an electric actuator for the air-mix door. Operation of the electric actuator is controlled in accordance with a control signal output from a control unit 60.

A mixing space is arranged on a blown air flow downstream side to the heater core 42 and the cold air bypass passage 35 in the air-conditioning case 31. The mixing space is a space for mixing the blown air heated by the heater core 42 and the blown air that has not heated by passing through the cold air bypass passage 35.

An opening aperture for discharges the blown air (i.e., air-conditioned wind) mixed in the mixing space to the vehicle compartment, which is a space to be air-conditioned, is disposed on a downstream portion in flow of the blown air of the air-conditioning case 31.

The opening apertures include a face opening aperture, a foot opening aperture, and a defroster opening aperture (any of them is not shown). A face opening aperture is an opening aperture for discharging the air-conditioning wind toward an upper body of an occupant in the vehicle compartment. The foot opening aperture is an opening aperture for blowing the air-conditioning wind toward a foot of the occupant. The defroster opening aperture is an opening aperture for blowing the air-conditioning wind toward an inner surface of a vehicle front window glass.

The face opening aperture, the foot opening aperture, and the defroster opening aperture are respectively connected to a face outlet port, a foot outlet port, and a defroster outlet port (not shown) provided in the vehicle compartment through ducts defining air passages.

Therefore, the air-mix door 34 adjusts an air volume ratio between an air volume passing through the heater core 42 and an air volume passing through the cold air bypass passage 35, thereby adjusting the temperature of the air-conditioning wind mixed in the mixing space. As a result, a temperature of the blown air (air-conditioning wind) to be discharged into the vehicle compartment from each outlet port is adjusted.

Further, a face door, a foot door, and a defroster door (none of which are shown) are arranged on the blown air flow upstream sides of the face opening aperture, the foot opening aperture, and the defroster opening aperture. The face door adjusts an opening area of the face opening aperture. The foot door adjusts an opening area of the foot opening aperture. The defroster door adjusts an opening area of the defroster opening aperture.

The face door, the foot door, and the defroster door form outlet mode switching doors for switching outlet modes. These doors are connected to an electric actuator for driving the outlet mode doors through a link mechanism or the like, and are rotationally operated in conjunction with the actuator. Operation of the electric actuator is also controlled in accordance with a control signal output from the control unit 60.

The outlet modes that are switched by an outlet mode switching device specifically includes a face mode, a bi-level mode, a foot mode, and the like.

The face mode is an outlet mode in which the face outlet port is fully opened to blow out air from the face outlet port toward an upper body of an occupant in the vehicle compartment. The bi-level mode is an outlet mode in which both the face outlet port and the foot outlet port are opened to blow out air toward the upper body and the foot of the occupant in the vehicle compartment. The foot mode is an outlet mode in which the foot outlet port is fully opened, and simultaneously the defroster outlet port is opened by a small opening degree, so that the air is blown mainly through the foot outlet port.

Further, the occupant can manually switch the outlet mode switching switch provided on the operation panel 70 to switch to the defroster mode. The defroster mode is an outlet mode in which the defroster outlet port is fully opened so that air is blown toward an inner face of the front windshield through the defroster outlet port.

Next, an outline of an electric control unit of the present embodiment will be described. The control unit 60 is a control device circuit configured of a well-known microcomputer including a CPU, ROM, RAM, and the like and peripheral circuits thereof. The control unit 60 performs various calculations and processes based on an air-conditioning control program stored in the ROM, and controls operations of the various control object devices 11, 14a-14c, 15a, 15b, 32, 41, 51, 53, and so on connected to an output of the control unit 60.

The control unit 60 includes at least one hardware processor circuit. In one embodiment, at least one hardware processor circuit is provided by a computer readable tangible non-transitory storage medium storing a program and a processing unit which can execute the program stored in the storage medium. In other embodiment, at least one hardware processor circuit is provided by a large scale logic circuit including huge number of gate circuits, including FPGA (Field Programmable Gate Array) and the like.

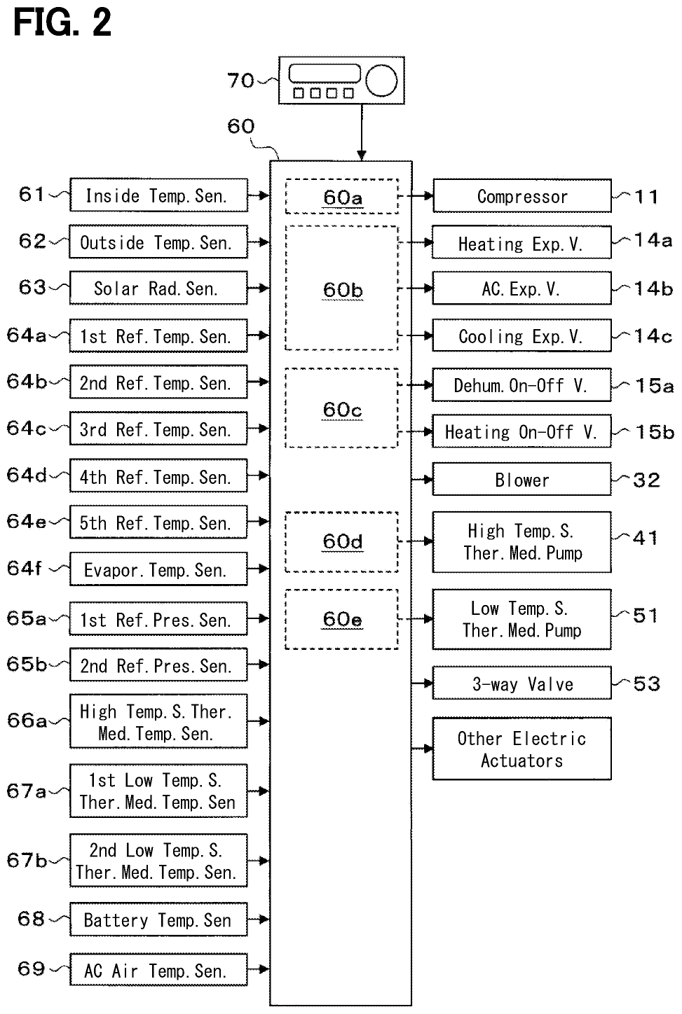

Further, a sensor group is connected to the input side of the control unit 60 as shown in the block diagram of FIG. 2. The sensor group includes an inside temperature sensor 61, an outside temperature sensor 62, a solar radiation sensor 63, a first refrigerant temperature sensor 64a to a fifth refrigerant temperature sensor 64e, an evaporator temperature sensor 64f, a first refrigerant pressure sensor 65a, a second refrigerant pressure sensor 65b, a high temperature side thermal medium temperature sensor 66a, a first low temperature side thermal medium temperature sensor 67a, a second low temperature side thermal medium temperature sensor 67b, a battery temperature sensor 68, and an air-conditioning air temperature sensor 69 and the like. Detecting signals of the sensor group are input into the control unit 60.

The inside air temperature sensor 61 is an inside air temperature detector that detects a vehicle-compartment temperature (an inside air temperature) Tr. The outside air temperature sensor 62 is an outside air temperature detector that detects a vehicle-compartment exterior temperature (an outside air temperature) Tam. The solar sensor 63 is a solar radiation amount detector that detects a solar radiation amount Ts radiated into the vehicle compartment.

The first refrigerant temperature sensor 64a is a discharged refrigerant temperature detection unit that detects a temperature T1 of the refrigerant discharged from the compressor 11. The second refrigerant temperature sensor 64b is a second refrigerant temperature detection unit that detects a temperature T2 of the refrigerant that has flowed out of the refrigerant passage of the water-refrigerant heat exchanger 12. The third refrigerant temperature sensor 64c is a third refrigerant temperature detection unit that detects a temperature T3 of the refrigerant that has flowed out of the outdoor heat exchanger 16.

The fourth refrigerant temperature sensor 64d is a fourth refrigerant temperature detection unit that detects a temperature T4 of the refrigerant that has flowed out of the indoor evaporator 18. The fifth refrigerant temperature sensor 64e is a fifth refrigerant temperature detection unit that detects a temperature T5 of the refrigerant flowing out from the refrigerant passage of the chiller 19.

The evaporator temperature sensor 64f is an evaporator temperature detection unit that detects a refrigerant evaporation temperature Tefin (hereinafter referred to as the evaporator temperature Tefin) in the indoor evaporator 18. The evaporator temperature sensor 64f of the present embodiment specifically detects a heat exchange fin temperature of the indoor evaporator 18.

The first refrigerant pressure sensor 65a is a first refrigerant pressure detection unit that detects a pressure P1 of the refrigerant flowing out of the refrigerant passage of the water-refrigerant heat exchanger 12. The second refrigerant pressure sensor 65b is a second refrigerant pressure detection unit that detects a pressure P2 of the refrigerant flowing out from the refrigerant passage of the chiller 19.

The high temperature side thermal medium temperature sensor 66a is a high temperature side thermal medium temperature detection unit that detects the high temperature side thermal medium temperature TWH, which is a temperature of the high temperature side thermal medium flowing out from the water passage of the water-refrigerant heat exchanger 12.

The first low temperature side thermal medium temperature sensor 67a is a first low temperature side thermal medium temperature detection unit that detects a first low temperature side thermal medium temperature TWL1 which is a temperature of the low temperature side thermal medium flowing out from the water passage of the chiller 19. The first low temperature side thermal medium temperature TWL1 is a temperature related to the temperature of the chiller 19.

The second low temperature side thermal medium temperature sensor 67b is a second low temperature side thermal medium temperature detecting unit that detects a second low temperature side thermal medium temperature TWL2 that is a temperature of the low temperature side thermal medium flowing out from the cooling heat exchange unit 52.

The battery temperature sensor 68 is a battery temperature detection unit that detects a battery temperature TB (that is, a temperature of the battery 80). The battery temperature sensor 68 of the present embodiment has a plurality of temperature sensors and detects temperatures at a plurality of locations of the battery 80. Therefore, the control unit 60 can also detect a temperature difference between the respective parts of the battery 80. Further, as the battery temperature TB, the average value of the detection values of the plurality of temperature sensors is adopted.

The conditioned air temperature sensor 69 is a conditioned-air temperature detector that detects a blowing air temperature TAV sent from the mixing space into the vehicle compartment.

Further, as shown in FIG. 2, an operation panel 70 disposed in the vicinity of the instrument panel in a front portion of the vehicle compartment is connected to an input side of the control unit 60, and operation signals from various operation switches provided on the operation panel 70 are input.

As various operation switches provided on the operation panel 70, specifically, there are an auto switch, an air conditioner switch, an air volume setting switch, a temperature setting switch, an outlet mode switching switch, and the like.

The auto switch is a switch for setting or canceling the automatic control operation of the vehicle air-conditioner. The air conditioner switch is a switch for requesting that the indoor evaporator 18 cools the blown air. The air volume setting switch is a switch for manually setting the air volume of the blower 32. The temperature setting switch is a switch for setting a target temperature Tset in the vehicle compartment. The outlet mode switching switch is a switch for manually setting the outlet port mode.

The control unit 60 of the present embodiment is integrally configured with control units to control various control object devices connected to the output side thereof. In the control unit 60, configurations (hardware and software) to control operations of control object devices configure control units to control operations of control object devices, respectively.

For example, in the control unit 60, the configuration to control the refrigerant discharge capacity of the compressor 11 (specifically, the rotation speed of the compressor 11) constitutes the compressor control unit 60a. In the control unit 60, the configurations to control operations of the heating expansion valve 14a, the air-conditioning expansion valve 14b, and the cooling expansion valve 14c constitute the expansion valve control unit 60b. In the control unit 60, the configurations to control operations of the dehumidifying on-off valve 15a and the heating on-off valve 15b constitute the refrigerant circuit switching control unit 60c.

Further, a configuration for controlling a pumping capability of the high temperature side thermal medium pump of the high temperature side thermal medium pump 41 constitutes the high temperature side thermal medium pump control unit 60d. A configuration for controlling a pumping capability of the low temperature side thermal medium pump 51 of the low temperature side thermal medium pump constitutes a low temperature side thermal medium pump control unit 60e.

Operations of the above configurations according to the present embodiment will be described next. As described above, the vehicle air-conditioner 1 of the present embodiment not only air-conditions the vehicle compartment, but also adjusts the temperature of the battery 80. Therefore, in the refrigeration cycle device 10, it is possible to perform operations by the following 11 kinds of operation modes by switching refrigerant circuits.

(1) Air-Conditioning Mode:

The air-conditioning mode is an operation mode in which the vehicle compartment is air-conditioned by cooling the blown air, and blowing the air into the vehicle compartment without cooling the battery 80.

(2) Series Dehumidifying and Heating Mode:

The series dehumidifying and heating mode is an operation mode in which the vehicle compartment is dehumidified and heated by reheating the blown air cooled and dehumidified, and blowing the air into the vehicle compartment without cooling the battery 80.

(3) Parallel Dehumidifying and Heating Mode:

The parallel dehumidifying and heating mode is an operation mode in which the vehicle compartment is dehumidified and heated by reheating the blown air cooled and dehumidified with a heating capacity greater than the series dehumidifying and heating mode, and blowing the air into the vehicle compartment without cooling the battery 80.

(4) Heating Mode:

The heating mode is an operation mode in which the vehicle compartment is heated by heating the blown air, and blowing the air into the vehicle compartment without cooling the battery 80.

(5) Air-Conditioning and Cooling Mode:

The air-conditioning and cooling mode is an operation mode in which the vehicle compartment is air-conditioned by cooling and discharging the blown air into the vehicle compartment, and simultaneously cooling the battery 80.

(6) Series Dehumidifying, Heating, and Cooling Mode:

The series dehumidifying, heating and cooling mode is an operation mode in which the vehicle compartment is dehumidified and heated by reheating and discharging the blown air cooled and dehumidified into the vehicle compartment, and simultaneously cooling the battery 80.

(7) Parallel Dehumidifying, Heating and Cooling Mode:

The parallel dehumidifying, heating and cooling mode is an operation mode in which the vehicle compartment is dehumidified and heated by reheating and discharging the blown air cooled and dehumidified into the vehicle compartment with a heating capacity greater than the series dehumidifying, heating and cooling mode, and simultaneously cooling the battery 80.

(8) Heating and Cooling Mode:

The heating and cooling mode is an operation mode in which the vehicle compartment is heated by heating and discharging the blown air into the vehicle compartment, and simultaneously cooling the battery 80.

(9) Series Heating and Cooling Mode:

The series heating and cooling mode is an operation mode in which the vehicle compartment is heated by heating and discharging the blown air into the vehicle compartment with a heating capacity greater than the heating and cooling mode, and simultaneously cooling the battery 80.

(10) Parallel Heating and Cooling Mode:

The parallel heating and cooling mode is an operation mode in which the vehicle compartment is heated by heating and discharging the blown air into the vehicle compartment with a heating capacity greater than the series heating and cooling mode, and simultaneously cooling the battery 80.

(11) Cooling Mode:

This is an operation mode in which the battery 80 is cooled without air-conditioning the vehicle compartment.

Among the operation modes (1) to (11), the heating and cooling mode (8) and the cooling mode (11) is a first mode in which the refrigerant does not evaporate in the outdoor heat exchanger 16 and the indoor evaporator 18, and the refrigerant evaporates in the chiller 19.

Among the operation modes (1) to (11), the other operation modes are a second mode in which the refrigerant evaporates at least one of the outdoor heat exchanger 16 and the indoor evaporator 18, and simultaneously the refrigerant also evaporates in the chiller 19.

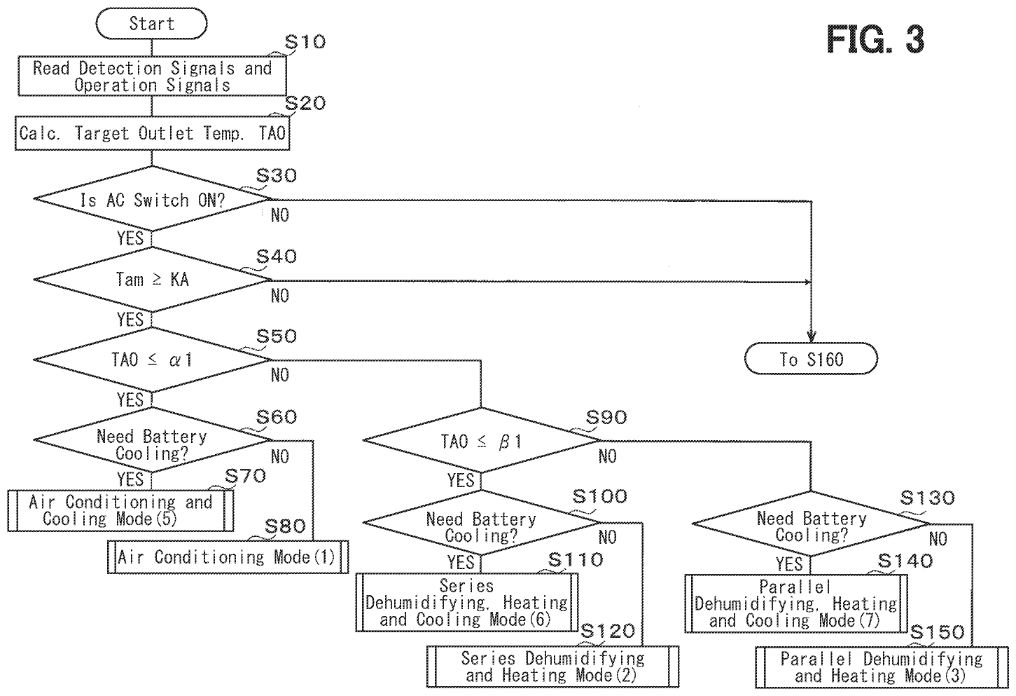

Switching between these operation modes is performed by executing an air-conditioning control program. The air-conditioning control program is executed when an automatic switch of the operation panel 70 is turned on by an operation of an occupant and automatic control of the vehicle compartment is set. The air conditioning control program will be described with reference to FIG. 3 to FIG. 22. Further, each control step shown in the flowchart of FIG. 3 and the like is a function performing unit in the control unit 60.

First, in step S10 of FIG. 3, the detecting signals of the above-described sensor group and the operation signals of the operation panel 70 are read. In the following step S20, a target outlet temperature TAO, which is a target temperature of the blown air blown into the vehicle compartment, is determined based on the detection signal and the operation signal inputted in step S10. Therefore, step S20 is a target outlet temperature determination unit.

Specifically, the target outlet temperature TAO is calculated by the following formula F1.

TAO=Kset×Tset−Kr×Tr−Kam×Tam−Ks×Ts+C (F1)

Tset is a set temperature of the vehicle compartment set by the temperature setting switch. Tr is a vehicle compartment temperature detected by the inside air sensor. Tam is a vehicle exterior temperature detected by the outside air sensor. Ts is a solar radiation amount detected by the solar radiation sensor. Kset, Kr, Kam, and Ks are control gains, and C is a constant for correction.

Next, in step S30, it is determined whether or not the air conditioner switch is ON (closed). The fact that the air-conditioner switch is turned on means that the occupant has requested cooling or dehumidification of the vehicle compartment. In other words, turning on the air conditioner switch means that the indoor evaporator 18 is required to cool the blown air.

When it is determined in step S30 that the air conditioner switch is turned on, the process proceeds to step S40. When it is determined in step S30 that the air conditioner switch is not turned on, the process proceeds to step S160.

In step S40, it is determined whether the outside air temperature Tam is equal to or higher than a predetermined reference outside air temperature KA (0° C. in this embodiment). The reference outside air temperature KA is set so that cooling the blown air by the indoor evaporator 18 is effective for air-conditioning or dehumidifying the air-conditioned space.

More specifically, in the present embodiment, a refrigerant evaporation temperature in the indoor evaporator 18 is kept equal to or higher than a frost formation suppression temperature (1° C. in the present embodiment) by the evaporation pressure regulating valve 20 changes in order to suppress frost formation on the indoor evaporator 18. Therefore, the indoor evaporator 18 cannot cool the blown air to a temperature lower than the frost formation suppressing temperature.

That is, when the temperature of the blown air flowing into the indoor evaporator 18 is lower than the temperature of the frost formation suppression temperature, it is not effective to cool the blown air by the indoor evaporator 18. Therefore, the reference outside air temperature KA is set to a value lower than the frost formation suppression temperature, and when the outside air temperature Tam is lower than the reference outside air temperature KA, the indoor evaporator 18 does not cool the blown air.

When it is determined in step S40 that the outside air temperature Tam is equal to or higher than the reference outside air temperature KA, the process proceeds to step S50. When it is determined in step S40 that the outside air temperature Tam is not equal to or higher than the reference outside air temperature KA, the process proceeds to step S160.

In step S50, it is determined whether the target outlet temperature TAO is equal to or lower than the air-conditioning reference temperature α1 (Alpha-1). The air-conditioning reference temperature α1 is determined by referring to a control map stored in advance in the control unit 60 based on the outside air temperature Tam. In the present embodiment, as shown in FIG. 5, the air-conditioning reference temperature α1 is determined to be a low value as the outside air temperature Tam decreases.

When it is determined in step S50 that the target outlet temperature TAO is equal to or lower than the air-conditioning reference temperature α1, the process proceeds to step S60. When it is determined in step S50 that the target outlet temperature TAO is not equal to or lower than the air-conditioning reference temperature α1, the process proceeds to step S90.

In step S60, it is determined whether or not the battery 80 needs to be cooled. Specifically, in the present embodiment, it is determined that a cooling of the battery 80 is necessary, when the battery temperature TB detected by the battery temperature sensor 68 is equal to or higher than a predetermined reference cooling temperature KTB (35° C. in the present embodiment.) Further, when the battery temperature TB is lower than the reference cooling temperature KTB, it is determined that the battery 80 does not need to be cooled.

When it is determined in step S60 that the battery 80 needs to be cooled, the process proceeds to step S70, and the air-conditioning and cooling mode (5) is selected as the operation mode of the refrigeration cycle device 10. When it is determined in step S60 that the battery 80 does not need to be cooled, the process proceeds to step S80, and the air-conditioning mode (1) is selected as the operation mode.

In step S90, it is determined whether the target outlet temperature TAO is equal to or lower than the dehumidifying reference temperature β1 (Beta-1). The dehumidifying reference temperature β1 is determined by referring to a control map stored in advance in the control unit 60 based on the outside air temperature Tam.

In the present embodiment, as shown in FIG. 5, the dehumidifying reference temperature β1 is determined to be a low value as the outside air temperature Tam decreases, similar to the air-conditioning reference temperature al. Further, the dehumidifying reference temperature β1 is determined to be a value higher than the air-conditioning reference temperature α1.

When it is determined in step S90 that the target outlet temperature TAO is equal to or lower than the dehumidifying reference temperature β1, the process proceeds to step S100. When it is determined in step S90 that the target outlet temperature TAO is not equal to or lower than the dehumidifying reference temperature β1, the process proceeds to step S130.

In step S100, it is determined whether or not the battery 80 needs to be cooled similar to step S60.

When it is determined in step S100 that the battery 80 needs to be cooled, the process proceeds to step S110, and the series dehumidifying, heating and cooling mode (6) is selected as the operation mode of the refrigeration cycle device 10. When it is determined in step S100 that the battery 80 does not need to be cooled, the process proceeds to step 120, and the (2) series dehumidifying and heating mode is selected as the operation mode of the refrigeration cycle device 10.

In step S130, it is determined whether or not the battery 80 needs to be cooled similar to step S60.

When it is determined in step S130 that the battery 80 needs to be cooled, the process proceeds to step S140, and the parallel dehumidifying, heating and cooling mode (7) is selected as the operation mode of the refrigeration cycle device 10. When it is determined in step S100 that the battery 80 does not need to be cooled, the process proceeds to step 150, and the parallel dehumidifying and heating mode (3) is selected as the operation mode of the refrigeration cycle device 10.

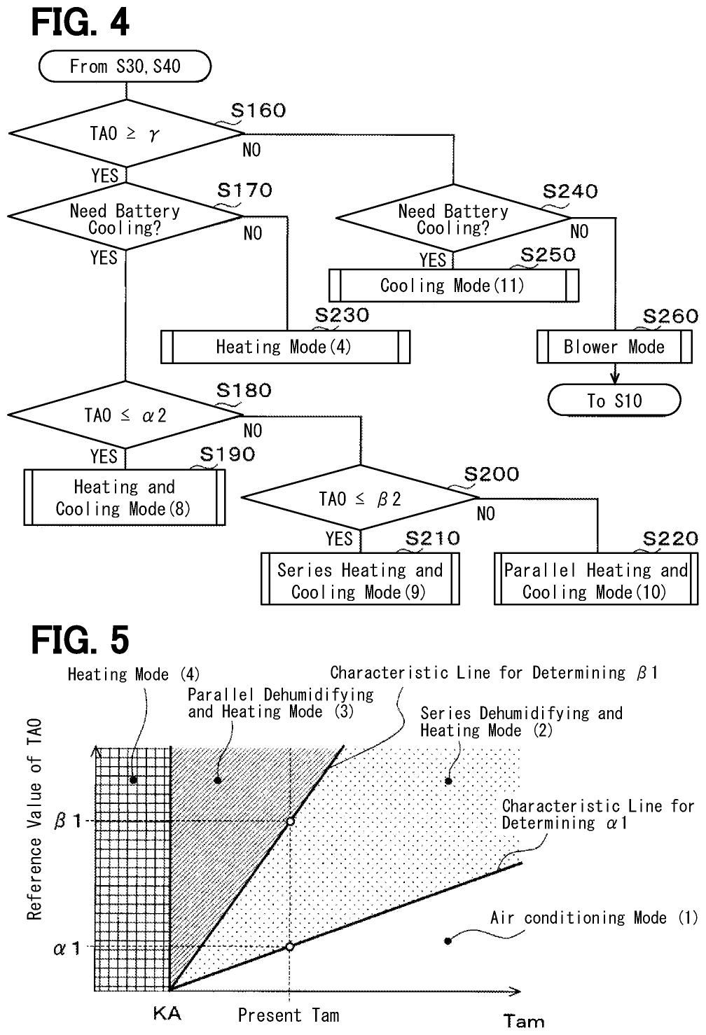

Subsequently, a case where the process proceeds from step S30 or step S40 to step S160 will be described. When the process proceeds from step S30 or step S40 to step S160, it is a case where cooling the blown air by the indoor evaporator 18 is not effective. In step S160, as shown in FIG. 4, it is determined whether the target outlet temperature TAO is equal to or higher than a heating reference temperature γ (Gamma).

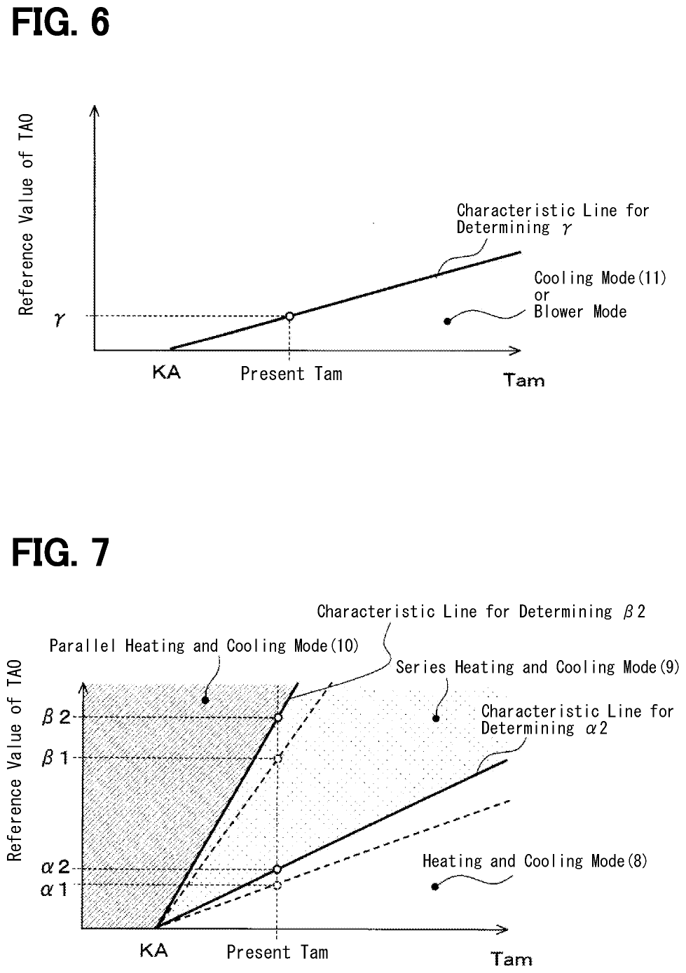

The heating reference temperature γ is determined by referring to a control map stored in advance in the control unit 60 based on the outside air temperature Tam. In the present embodiment, as shown in FIG. 6, the heating reference temperature γ is determined to be a low value as the outside air temperature Tam decreases. The heating reference temperature γ is set so that heating the blown air by the heater core 42 is effective for heating the air-conditioned space.

When it is determined in step S160 that the target outlet temperature TAO is equal to or higher than the heating reference temperature γ, it is a case where the blown air needs to be heated by the heater core 42, and the process proceeds to step S170. When it is determined in step S160 that the target outlet temperature TAO is not equal to or higher than the heating reference temperature γ, it is a case where the blown air does not need to be heated by the heater core 42, and the process proceeds to step S240.

In step S170, it is determined whether or not the battery 80 needs to be cooled similar to step S60.

When it is determined in step S170 that the battery 80 needs to be cooled, the process proceeds to step S180. When it is determined in step S170 that the battery 80 does not need to be cooled, the process proceeds to step S230, and the heating mode (4) is selected as the operation mode.

If it is determined in step S170 that the battery 80 needs to be cooled and the process proceeds to step S180, it is necessary to perform both heating of the vehicle compartment and cooling of the battery 80. Therefore, in the refrigeration cycle apparatus 10, it is necessary to adjust appropriately the heat dissipation amount of the refrigerant dissipated to the high temperature side thermal medium in the water-refrigerant heat exchanger 12 and the heat absorb amount of the refrigerant absorbed from the low temperature side thermal medium in the chiller 19.

Therefore, in the refrigeration cycle device 10 of the present embodiment, when it is required to perform both heating the vehicle compartment and cooling the battery 80, the operation mode is switched as shown in steps S180 to S220 in FIG. 4. Specifically, three operation modes of the heating and cooling mode (8), the series heating and cooling mode (9), and the parallel heating and cooling mode (10) are switched.

In step S180, it is determined whether the target outlet temperature TAO is equal to or lower than a first cooling reference temperature α2 (Alpha-2). The first cooling reference temperature α2 is determined by referring to a control map stored in advance in the control unit 60 based on the outside air temperature Tam.

In the present embodiment, as shown in FIG. 7, the first cooling reference temperature α2 is determined to be a low value as the outside air temperature Tam decreases. Further, at the same outside air temperature Tam, the first cooling reference temperature α2 is determined to be higher than the air-conditioning reference temperature α1.

When it is determined in step S180 that the target outlet temperature TAO is equal to or lower than the first cooling reference temperature α2, the process proceeds to step S190, and the heating and cooling mode (8) is selected as the operation mode. When it is determined in step S180 that the target outlet temperature TAO is not equal to or lower than the first cooling reference temperature α2, the process proceeds to step S200.

In step S200, it is determined whether the target outlet temperature TAO is equal to or lower than a second cooling reference temperature β2 (Beta-2). The second cooling reference temperature β2 is determined by referring to a control map stored in advance in the control unit 60 based on the outside air temperature Tam.

In the present embodiment, as shown in FIG. 7, the second cooling reference temperature β2 is determined to be a low value as the outside air temperature Tam decreases, similar to the first cooling reference temperature α2. Further, the second cooling reference temperature β2 is determined to be higher than the first cooling reference temperature α2. Further, at the same outside air temperature Tam, the second cooling reference temperature β2 is determined to be higher than the dehumidifying reference temperature β1.

When it is determined in step S200 that the target outlet temperature TAO is equal to or lower than a second cooling reference temperature β2 (Beta-2), the process proceeds to step S210, and the series heating and cooling mode (9) is selected as the operation mode. When it is determined in step S200 that the target outlet temperature TAO is not equal to or lower than the second cooling reference temperature β2, the process proceeds to step S220, and the parallel heating and cooling mode (10) is selected as the operation mode.

Subsequently, a case where the process proceeds from step S160 to step S240 will be described. When the process proceeds from step S160 to step S240, it is not necessary to heat the blown air by the heater core 42. Therefore, in step S240, it is determined whether or not the battery 80 needs to be cooled similar to step S60.

When it is determined in step S240 that the battery 80 needs to be cooled, the process proceeds to step S250, and the cooling mode (11) is selected as the operation mode. When it is determined in step S200 that the battery 80 does not need to be cooled, the process proceeds to step S260, the blower mode is selected as the operation mode, and the process returns to step S10.

The blower mode is an operation mode in which the blower 32 is operated according to the setting signal set by the air volume setting switch. In addition, in step S240, when it is determined that the cooling of the battery 80 is not necessary, it is a case where operating the refrigeration cycle device 10 for air-conditioning of the vehicle compartment and cooling of the battery is not necessary. Therefore, in step S260, the blower 32 may be stopped.

In the air-conditioning control program of the present embodiment, the operation mode of the refrigeration cycle device 10 is switched as described above. Furthermore, the air-conditioning control program controls not only the operation of each component of the refrigeration cycle device 10 but also the operation of other component. Specifically, the air-conditioning control program also controls the operation of the high temperature side thermal medium pump 41 of the high temperature side thermal medium circuit 40, the low temperature side thermal medium pump 51 of the low temperature side thermal medium circuit 50, and the three-way valve 53.

Specifically, the control unit 60 controls the operation of the high temperature side thermal medium pump 41 so as to perform a reference pumping capability for each predetermined operation mode regardless of the operation mode of the refrigeration cycle device 10 described above.

Therefore, in the high temperature side thermal medium circuit 40, when the high temperature side thermal medium is heated in the water passage of the water-refrigerant heat exchanger 12, the heated high temperature side thermal medium is pumped to the heater core 42. The high temperature side thermal medium that has flowed into the heater core 42 exchanges heat with the blown air. Accordingly, the blown air is heated. The high temperature side thermal medium that has flowed out of the heater core 42 is sucked into the high temperature side thermal medium pump 41 and is pumped to the water-refrigerant heat exchanger 12.

Further, the control unit 60 controls the operation of the low temperature side thermal medium pump 51 so as to perform a reference pumping capability for each predetermined operation mode regardless of the operation mode of the refrigeration cycle device 10 described above.

Further, when the second low temperature side thermal medium temperature TWL2 is equal to or higher than the outside air temperature Tam, the control unit 60 controls operation of the three-way valve 53 so that the low temperature side thermal medium flowing out from the cooling heat exchange unit 52 to flow into the low temperature side radiator 54. The second low temperature side thermal medium temperature TWL2 is detected by the second low temperature side thermal medium temperature sensor 67b.

When the second low temperature side thermal medium temperature TWL2 is not equal to or higher than the outside air temperature Tam, the operation of the three way valve 53 is controlled so that the low temperature side thermal medium 52 flowing out from the cooling heat exchange unit 52 is sucked into the low temperature side thermal medium pump 51.

Therefore, in the low temperature side thermal medium circuit 50, when the low temperature side thermal medium is cooled in the water passage of the chiller 19, the cooled low temperature side thermal medium is pumped to the cooling heat exchange unit 52. The low temperature side thermal medium that has flowed into the cooling heat exchange unit 52 absorbs heat from the battery 80. Consequently, the battery 80 is cooled. The low temperature side thermal medium flowing out from the cooling heat exchange unit 52 flows into the three-way valve 53.

At this time, when the second low temperature side thermal medium temperature TWL2 is equal to or higher than the outside air temperature Tam, the low temperature side thermal medium flowing out from the cooling heat exchange unit 52 flows into the low temperature side radiator 54 and dissipates heat to the outside air. Thereby, the low temperature side thermal medium is cooled until it becomes equal to the outside air temperature Tam. The low temperature side thermal medium flowing out from the low temperature side radiator 54 is sucked into the low temperature side thermal medium pump 51 and is pumped to the chiller 19.

On the other hand, when the second low-temperature side thermal medium temperature TWL2 is lower than the outside air temperature Tam, the low-temperature side thermal medium flowing out from the cooling heat exchange unit 52 is sucked into the low-temperature side thermal medium pump 51 and is pumped to the chiller 19. Therefore, the temperature of the low temperature side thermal medium sucked into the low temperature side thermal medium pump 51 becomes equal to or lower than the outside air temperature Tam.

Detailed operation of the vehicle air-conditioner 1 in each operation mode will be described below. The control maps referred to in each operation mode described below are stored in advance in the control unit 60 for each operation mode. The control maps corresponding to each operation mode may be equivalent to each other or may be different from each other.

(1) Air-Conditioning Mode

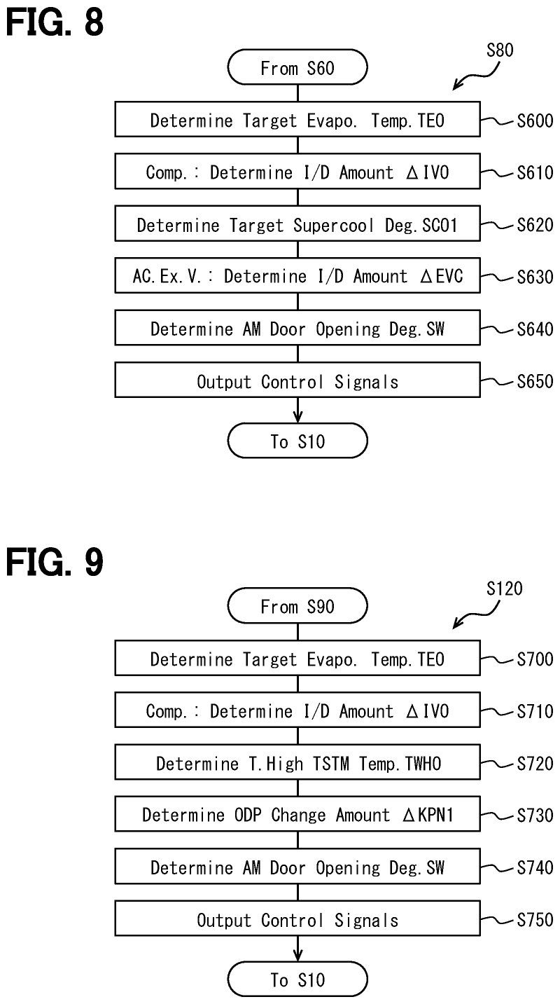

In the air-conditioning mode, the control unit 60 executes the control flow of the air-conditioning mode shown in FIG. 8. First, in step S600, a target evaporator temperature TEO is determined. The target evaporator temperature TEO is determined by referring to the controlling map stored in advance in the control unit 60 based on the target outlet temperature TAO. In the control map of the present embodiment, it is determined that the target evaporator temperature TEO increases as the target outlet temperature TAO increases.

In step S610, the increase/decrease amount ΔIVO (Delta-IVO) of the rotation speed of the compressor 11 is determined. The increase/decrease amount ΔIVO is determined so that the evaporator temperature Tefin approaches the target evaporator temperature TEO, by the feedback control method, based on a deviation between the target evaporator temperature TEO and the evaporator temperature Tefin detected by the evaporator temperature sensor 64f.

In step S620, a target sub-cool degree SCO1 of the refrigerant flowing out of the outdoor heat exchanger 16 is determined. The target sub-cool degree SCO1 is determined by referring to the control map, for example, based on the outside air temperature Tam. In the control map of this embodiment, the target sub-cool degree SCO1 is determined so that the coefficient of performance (COP) of the cycle approaches the maximum value.

In step S630, the increase/decrease amount ΔEVC (Delta-EVC) of the orifice opening of the air-conditioning expansion valve 14b is determined. The increase/decrease amount ΔEVC is determined so that the sub-cool degree SC1 of the refrigerant on the outlet side of the outdoor heat exchanger 16 approaches the target sub-cool degree SCO1, by the feedback control method, based on a deviation between the target sub-cool degree SCO1 and the sub-cool degree SC1 of the refrigerant on the outlet side of the outdoor heat exchanger 16.

The sub-cool degree SC1 of the refrigerant on the outlet side of the outdoor heat exchanger 16 is calculated based on the temperature T3 detected by the third refrigerant temperature sensor 64c and the pressure P1 detected by the first refrigerant pressure sensor 65a.

In step S640, the opening degree SW of the air-mix door 34 is calculated by using the following formula F2.

SW={TAO−(Tefin+C2)}/{TWH−(Tefin+C2)} (F2)

The TWH is a high temperature side thermal medium temperature detected by the high temperature side thermal medium temperature sensor 66a. C2 is a constant for control.

In step S650, the refrigeration cycle device 10 is switched to a refrigerant circuit in the air-conditioning mode. Specifically, the heating expansion valve 14a is fully opened, the cooling expansion valve 14c is fully closed, the dehumidifying on-off valve 15a is closed, and the heating on-off valve 15b is closed. Furthermore, control signals or control voltages are output to each control target device so that the control state determined in steps S610, S630, and S640 is obtained, and the process returns to step S10.

Therefore, in the refrigeration cycle device 10 in the air-conditioning mode, a steam compression type refrigeration cycle is configured, wherein the refrigerant circulates in an order of the compressor 11, the water-refrigerant heat exchanger 12, the heating expansion valve 14a, the outdoor heat exchanger 16, the check valve 17, the air-conditioning expansion valve 14b, the indoor evaporator 18, the evaporation pressure regulating valve 20, the accumulator 21, and the compressor 11.

That is, in the refrigeration cycle apparatus 10 in the air-conditioning mode, a steam compression type refrigeration cycle is configured, wherein the water-refrigerant heat exchanger 12 and the outdoor heat exchanger 16 function as radiators and the indoor evaporator 18 functions as an evaporator.

According to this, the blown air can be cooled at the indoor evaporator 18, and simultaneously the high temperature side thermal medium can be heated at the water-refrigerant heat exchanger 12.

Therefore, in the vehicle air-conditioner 1 in the air-conditioning mode, the blown air, whose temperature is adjusted to approach the target outlet temperature TAO by reheating a part of the blown air cooled by the indoor evaporator 18 by the heater core 42, by adjusting the opening degree of the air-mix door 34, is discharged to the vehicle compartment. As a result, it is possible to perform an air-conditioning of the vehicle compartment.

(2) Series Dehumidifying and Heating Mode

In the series dehumidifying and heating mode, the control unit 60 executes the control flow of the series dehumidifying and heating mode shown in FIG. 9. First, in step S700, the target evaporator temperature TEO is determined similar to the air-conditioning mode. In step S710, the increase/decrease amount ΔIVO of the rotation speed of the compressor 11 is determined similar to the air-conditioning mode.

In step S720, the target high temperature side thermal medium temperature TWHO of the high temperature side thermal medium is determined in order to heat the blower air by the heater core 42. The target high temperature side thermal medium temperature TWHO is determined by referring to a control map based on the target outlet temperature TAO and the efficiency of the heater core 42. In the control map of the present embodiment, it is determined that the target high temperature side thermal medium temperature TWHO increases as the target outlet temperature TAO increases.

In step S730, a change amount ΔKPN1 (Delta-KPN1) of the opening pattern KPN1 is determined. The opening degree pattern KPN1 is a parameter for determining a combination of the orifice opening degree of the heating expansion valve 14a and the orifice opening degree of the air-conditioning expansion valve 14b.

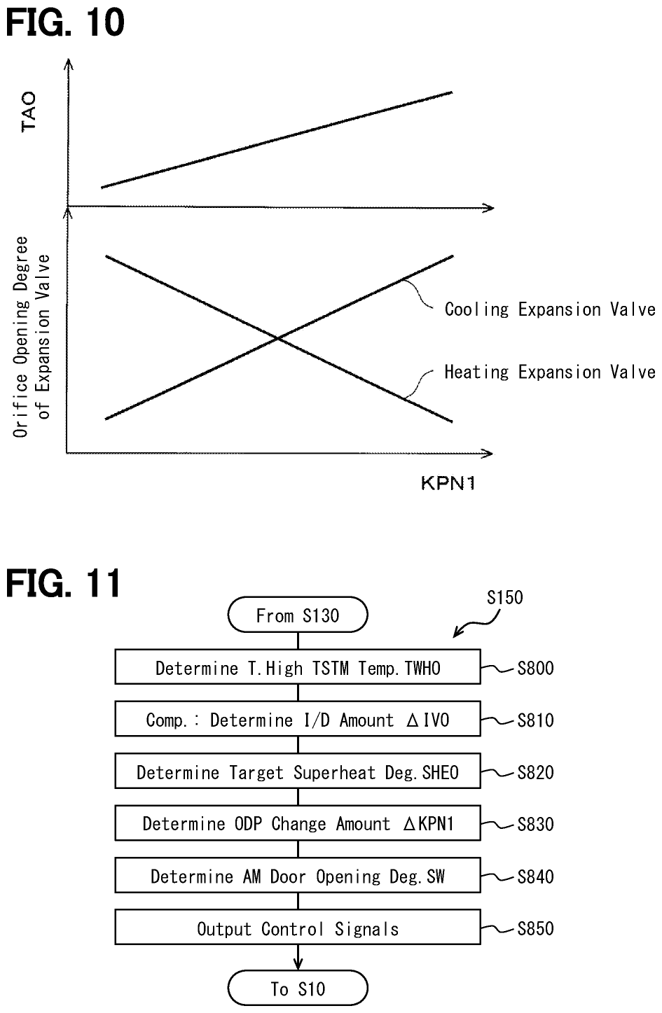

Specifically, in the series dehumidifying and heating mode, as shown in FIG. 10, the opening degree pattern KPN1 increases as the target outlet temperature TAO increases. As the opening degree pattern KPN1 getting great, the orifice opening degree of the heating expansion valve 14a decreases, and the orifice opening degree of the air-conditioning expansion valve 14b increases.

In step S740, the opening degree SW of the air-mix door 34 is calculated similar to the air-conditioning mode. Here, in the series dehumidifying and heating mode, since the target outlet temperature TAO is higher than that in the air-conditioning mode, the opening degree SW of the air-mix door 34 approaches 100%. Therefore, in the series dehumidifying and heating mode, the opening degree of the air-mix door 34 is determined so that almost the entire flow amount of the blown air after passing through the indoor evaporator 18 passes through the heater core 42.

In step S750, the refrigeration cycle device 10 is switched to the refrigerant circuit in the series dehumidifying and heating mode. Specifically, the cooling expansion valve 14c is fully closed, the dehumidifying on-off valve 15a is closed, and the heating on-off valve 15b is closed. Furthermore, control signals or control voltages are output to each control object device so that the control state determined in steps S710, S730, and S740 is obtained, and the process returns to step S10.

Therefore, in the refrigeration cycle device 10 in the series dehumidifying and heating mode, a steam compression type refrigeration cycle is configured, wherein the refrigerant circulates in an order of the compressor 11, the water-refrigerant heat exchanger 12, the heating expansion valve 14a, the outdoor heat exchanger 16, the check valve 17, the air-conditioning expansion valve 14b, the indoor evaporator 18, the evaporation pressure regulating valve 20, the accumulator 21, and the compressor 11.

That is, in the refrigeration cycle device 10 in the series dehumidifying and heating mode, a steam compression refrigeration cycle is configured, wherein the water-refrigerant heat exchanger 12 functions as a radiator and the indoor evaporator 18 functions as an evaporator.

Further, when a saturation temperature of the refrigerant in the outdoor heat exchanger 16 is higher than the outside air temperature Tam, a cycle in which the outdoor heat exchanger 16 functions as a radiator is configured. Further, when the saturation temperature of the refrigerant in the outdoor heat exchanger 16 is lower than the outside air temperature Tam, a cycle in which the outdoor heat exchanger 16 functions as an evaporator is configured.

According to this, the blown air can be cooled at the indoor evaporator 18, and simultaneously the high temperature side thermal medium can be heated at the water-refrigerant heat exchanger 12. Therefore, in the vehicle air-conditioner 1 in the series dehumidifying and heating mode, it is possible to perform a dehumidifying and heating of the vehicle compartment by discharging the blown air which is cooled and dehumidified by the indoor evaporator 18, and is reheated by the heater core 42 into the vehicle compartment.

Further, when the saturation temperature of the refrigerant in the outdoor heat exchanger 16 is higher than the outside air temperature Tam, the opening degree pattern KPN1 is increased as the target outlet temperature TAO increases. As a result, the saturation temperature of the refrigerant in the outdoor heat exchanger 16 is lowered to reduce a difference to the outside air temperature Tam. As a result, it is possible to increase a heat dissipation amount form the refrigerant in the water-refrigerant heat exchanger 12 by reducing a heat dissipation amount from the refrigerant in the outdoor heat exchanger 16.

Further, when the saturation temperature of the refrigerant in the outdoor heat exchanger 16 is higher than the outside air temperature Tam, the opening degree pattern KPN1 is increased as the target outlet temperature TAO increases. As a result, the saturation temperature of the refrigerant in the outdoor heat exchanger 16 is lowered to expand a difference to the outside air temperature Tam. As a result, it is possible to increase a heat dissipation amount form the refrigerant in the water-refrigerant heat exchanger 12 by increasing a heat absorption amount to the refrigerant in the outdoor heat exchanger 16.

That is, in the series dehumidifying and heating mode, it is possible to increase the heat dissipation amount from the refrigerant to the high temperature side thermal medium in the water-refrigerant heat exchanger 12 by increasing the opening degree pattern KPN1 as the target outlet temperature TAO increases. Therefore, in the series dehumidifying and heating mode, it is possible to improve the heating capacity of the blown air in the heater core 42 as the target outlet temperature TAO increases.

(3) Parallel Dehumidifying and Heating Mode

In the parallel dehumidifying and heating mode, the control unit 60 executes the control flow of the parallel dehumidifying and heating mode shown in FIG. 11. First, in step S800, the target high temperature side thermal medium temperature TWHO of the high temperature side thermal medium is determined similar to the series dehumidifying and heating mode in order to heat the blown air at the heater core 42.

In step S810, the increase/decrease amount ΔIVO of the rotation speed of the compressor 11 is determined. In the parallel dehumidification heating mode, the increase/decrease amount ΔIVO is determined so that the high temperature side thermal medium temperature TWH approaches the target high temperature side thermal medium temperature TWHO by the feedback control method based on a deviation between the target high temperature side thermal medium temperature TWHO and the high temperature side thermal medium temperature TWH.

In step S820, the target superheat degree SHEO of the refrigerant on the outlet side of the indoor evaporator 18 is determined. A predetermined constant (5° C. in this embodiment) may be adopted as the target superheat degree SHEO.

In step S830, the change amount ΔKPN1 of the opening pattern KPN1 is determined. In the parallel dehumidifying and heating mode, the superheat degree SHE is determined to approach the target superheat degree SHEO, by the feedback control method, based on a deviation between the target superheat degree SHEO and the superheat degree SHE of the refrigerant on the outlet side of the indoor evaporator 18.

The superheat degree SHE of the outlet side refrigerant of the indoor evaporator 18 is calculated based on the temperature T4 detected by the fourth refrigerant temperature sensor 64d and the evaporator temperature Tefin.

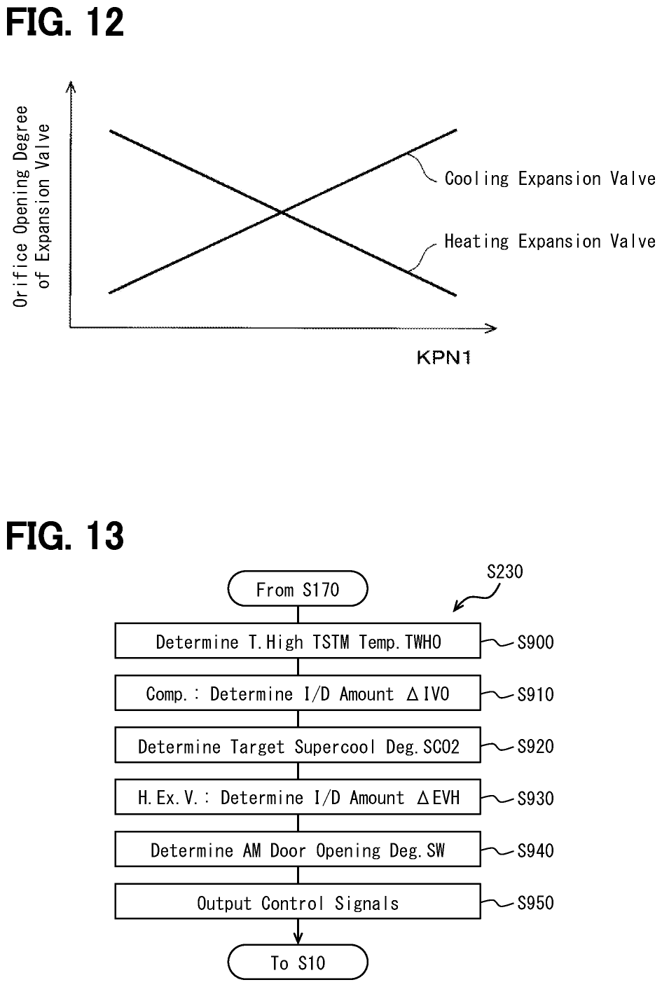

Further, in the parallel dehumidifying and heating mode, as shown in FIG. 12, as the opening degree pattern KPN1 getting great, the orifice opening degree of the heating expansion valve 14a decreases and the orifice opening degree of the air-conditioning expansion valve 14b increases. Therefore, when the opening degree pattern KPN1 increases, the flow amount of the refrigerant flowing into the indoor evaporator 18 increases, and the superheat degree SHE of the refrigerant on the outlet side of the indoor evaporator 18 decreases.

In step S840, the opening degree SW of the air-mix door 34 is calculated similar to the air-conditioning mode. Here, in the parallel dehumidifying and heating mode, since the target outlet temperature TAO is higher than that in the air-conditioning mode, the opening degree SW of the air-mix door 34 approaches 100% similar to the series dehumidifying and heating mode. Therefore, in the parallel dehumidifying and heating mode, the opening degree of the air-mix door 34 is determined so that almost the entire flow amount of the blown air after passing through the indoor evaporator 18 passes through the heater core 42.

In step S850, the refrigeration cycle device 10 is switched to the refrigerant circuit in the parallel dehumidifying and heating mode. Specifically, the cooling expansion valve 14c is fully closed, the dehumidifying on-off valve 15a is opened, and the heating on-off valve 15b is opened. Furthermore, control signals or control voltages are output to each control object device so that the control state determined in steps S810, S830, and S840 is obtained, and the process returns to step S10.

Therefore, in the refrigeration cycle device 10 in the parallel dehumidifying and heating mode, a steam compression type refrigeration cycle is configured, wherein the refrigerant circulates in an order of the compressor 11, the water-refrigerant heat exchanger 12, the heating expansion valve 14a, the outdoor heat exchanger 16, the heating passage 22b, the accumulator 21, and the compressor 11, and simultaneously the refrigerant circulates in an order of the compressor 11, the water-refrigerant heat exchanger 12, the bypass passage 22a, the air-conditioning expansion valve 14b, the indoor evaporator 18, the evaporation pressure regulating valve 20, the accumulator 21, and the compressor 11.

That is, in the refrigeration cycle apparatus 10 in the parallel dehumidifying and heating mode, a refrigeration cycle is configured in which the water-refrigerant heat exchanger 12 functions as a radiator, and the outdoor heat exchanger 16 and the indoor evaporator 18 connected in parallel to the refrigerant flow functions as evaporators.

According to this, the blown air can be cooled at the indoor evaporator 18, and simultaneously the high temperature side thermal medium can be heated at the water-refrigerant heat exchanger 12. Therefore, in the vehicle air-conditioner 1 in the parallel dehumidifying and heating mode, it is possible to perform a dehumidifying and heating of the vehicle compartment by discharging the blown air which is cooled and dehumidified by the indoor evaporator 18, and is reheated by the heater core 42 into the vehicle compartment.

Further, in the refrigeration cycle device 10 in the parallel dehumidifying and heating mode, the outdoor heat exchanger 16 and the indoor evaporator 18 are connected in parallel to the refrigerant flow, and the evaporation pressure regulating valve 20 is arranged on the downstream side of the indoor evaporator 18. Thereby, the refrigerant evaporation temperature in the outdoor heat exchanger 16 can be made lower than the refrigerant evaporation temperature in the indoor evaporator 18.

Therefore, in the parallel dehumidifying and heating mode, the heat absorption amount of the refrigerant in the outdoor heat exchanger 16 can be increased more than that in the series dehumidifying and heating mode, and the heat dissipation amount of the refrigerant in the water-refrigerant heat exchanger 12 can be increased. As a result, in the parallel dehumidifying and heating mode, the blown air can be reheated with a higher heating capacity than in the series dehumidifying and heating mode.

(4) Heating Mode

In the heating mode, the control unit 60 executes the control flow of the heating mode shown in FIG. 13. First, in step S900, the target high temperature side thermal medium temperature TWHO of the high temperature side thermal medium is determined similar to the parallel dehumidifying and heating mode. In step S910, the increase/decrease amount ΔIVO of the rotation speed of the compressor 11 is determined similar to the parallel dehumidifying and heating mode.

In step S920, the target sub-cool degree SCO2 of the refrigerant flowing out from the refrigerant passage of the water-refrigerant heat exchanger 12 is determined. The target sub-cool degree SCO2 is determined by referring to a control map based on the suction temperature of the blown air flowing into the indoor evaporator 18 or the outside air temperature Tam. In the control map of the present embodiment, the target sub-cool degree SCO2 is determined so that the coefficient of performance (COP) of the cycle approaches the maximum value.

In step S930, the increase/decrease amount ΔEVH (Delta-EVH) of the orifice opening of the heating expansion valve 14a is determined. The increase/decrease amount ΔEVH is determined so that the sub-cool degree SC2 of the refrigerant flowing out from the refrigerant passage of the water-refrigerant heat exchanger 12 approaches the target sub-cool degree SCO2, by the feedback control method, based on a deviation between the target sub-cool degree SCO2 and the sub-cool degree SC2 of the refrigerant flowing out of the refrigerant passage of the water-refrigerant heat exchanger 12.

The sub-cool degree SC2 of the refrigerant flowing out of the refrigerant passage of the water-refrigerant heat exchanger 12 is calculated based on the temperature T2 detected by the second refrigerant temperature sensor 64b and the pressure P1 detected by the first refrigerant pressure sensor 65a.

In step S940, the opening degree SW of the air-mix door 34 is calculated similar to the air-conditioning mode. Here, in the heating mode, since the target outlet temperature TAO is higher than that in the air-conditioning mode, the opening degree SW of the air-mix door 34 approaches 100%. Therefore, in the heating mode, the opening degree of the air-mix door 34 is determined so that almost the entire flow amount of the blown air after passing through the indoor evaporator 18 passes through the heater core 42.

In step S950, in order to switch the refrigerating cycle device 10 to the refrigerant circuit in the heating mode, the air-conditioning expansion valve 14b is fully closed, the cooling expansion valve 14c is fully closed, the dehumidifying on-off valve 15a is closed, and the heating on-off valve 15b is closed. Furthermore, control signals or control voltages are output to each control object device so that the control state determined in steps S910, S930, and S940 is obtained, and the process returns to step S10.

Therefore, in the refrigeration cycle apparatus 10 in the heating mode, a steam compression type refrigeration cycle is configured, wherein the refrigerant circulates in an order of the compressor 11, the water-refrigerant heat exchanger 12, the heating expansion valve 14a, the outdoor heat exchanger 16, the heating passage 22b, the accumulator 21, and the compressor 11.

That is, in the refrigerating cycle device 10 in the heating mode, a refrigerating cycle is configured in which the water-refrigerant heat exchanger 12 functions as a radiator and the outdoor heat exchanger 16 functions as an evaporator.

According to this, it is possible to heat the high temperature side thermal medium at the water-refrigerant heat exchanger 12. Therefore, in the vehicle air-conditioner 1 in the heating mode, it is possible to perform a heating of the vehicle compartment by discharging the blown air the blown air which is heated by the heater core 42 into the vehicle compartment.

(5) Air-Conditioning and Cooling Mode

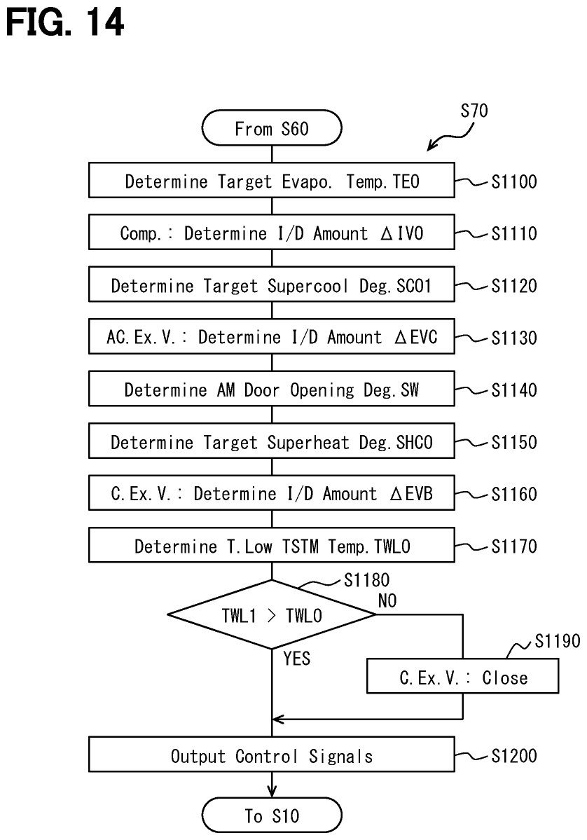

In the air-conditioning and cooling mode, the control unit 60 executes the control flow in the air-conditioning and cooling mode shown in FIG. 14. First, in steps S1100 to S1140, the target evaporator temperature TEO, the increase/decrease amount ΔIVO of the rotation speed of the compressor 11, the increase/decrease amount ΔEVC of an orifice opening degree of the air-conditioning expansion valve 14b, and the opening degree SW of the air-mix door 34 is determined similar to steps S600 to S640 in the air-conditioning mode.

Next, in step S1150, the target superheat degree SHCO of the refrigerant on the outlet side of the refrigerant passage of the chiller 19 is determined. A predetermined constant (5° C. in this embodiment) may be adopted as the target superheat degree SHCO.

In step S1160, the increase/decrease amount ΔEVB (Delta-EVB) of the orifice opening degree of the cooling expansion valve 14c is determined. In the air-conditioning and cooling mode, the increase/decrease amount ΔEVB is determined so that the superheat degree SHC approaches the target superheat degree SHCO of the refrigerant flowing out from the refrigerant passage of the chiller 19, by the feedback control method, based on a deviation between the target superheat degree SHCO and the superheat degree SHC of the refrigerant flowing out from the refrigerant passage of the chiller 19.

The superheat degree SHC of the refrigerant flowing out from the refrigerant passage of the chiller 19 is calculated based on the temperature T5 detected by the fifth refrigerant temperature sensor 64e and the pressure P2 detected by the second refrigerant pressure sensor 65b.

In step S1170, the target low temperature side thermal medium temperature TWLO of the low temperature side thermal medium flowing out from the water passage of the chiller 19 is determined. The target low temperature side thermal medium temperature TWLO is determined by the first fixed value TWLO1 stored in advance in the control unit 60.

In step S1180, it is determined whether the first low temperature side thermal medium temperature TWL1 detected by the first low temperature side thermal medium temperature sensor 67a is higher than the target low temperature side thermal medium temperature TWLO.

When it is determined in step S1180 that the first low temperature side thermal medium temperature TWL1 is higher than the target low temperature side thermal medium temperature TWLO, the process proceeds to step S1200. When it is not determined in step S1180 that the first low temperature side thermal medium temperature TWL1 is higher than the target low temperature side thermal medium temperature TWLO, the process proceeds to step S1190. In step S1190, the cooling expansion valve 14c is fully closed and the process proceeds to step S1200.

In step S1200, the refrigeration cycle device 10 is switched to a refrigerant circuit in the air-conditioning and cooling mode. Specifically, the heating expansion valve 14a is fully opened, the dehumidifying on-off valve 15a is closed, and the heating on-off valve 15b is closed. Furthermore, control signals or control voltages are output to each control object device so that the control state determined in steps S1110, S1130, S1140, S1160 and S1190 is obtained, and the process returns to step S10.

Therefore, in the refrigeration cycle device 10 in the air-conditioning and cooling mode, a steam compression type refrigeration cycle is configured, wherein the refrigerant circulates in an order of the compressor 11, the water-refrigerant heat exchanger 12, the heating expansion valve 14a, the outdoor heat exchanger 16, the check valve 17, the air-conditioning expansion valve 14b, the indoor evaporator 18, the evaporation pressure regulating valve 20, the accumulator 21, and the compressor 11, and simultaneously the refrigerant circulates in an order of the compressor 11, the water-refrigerant heat exchanger 12, the heating expansion valve 14a, the outdoor heat exchanger 16, the check valve 17, the cooling expansion valve 14c, the chiller 19, the evaporation pressure regulating valve 20, the accumulator 21, and the compressor 11.

That is, in the refrigeration cycle device 10 in the air-conditioning and cooling mode, a steam compression type refrigeration cycle is configured, wherein the water-refrigerant heat exchanger 12 and the outdoor heat exchanger 16 function as radiators, and the indoor evaporator 18 and the chiller 19 function as evaporators.

According to this, the blown air can be cooled at the indoor evaporator 18, and simultaneously the high temperature side thermal medium can be heated at the water-refrigerant heat exchanger 12. Further, the chiller 19 can cool a low pressure side thermal medium.

Therefore, in the vehicle air-conditioner 1 in the air-conditioning and cooling mode, the blown air, whose temperature is adjusted to approach the target outlet temperature TAO by reheating a part of the blown air cooled by the indoor evaporator 18 by the heater core 42, by adjusting the opening degree of the air-mix door 34, is discharged to the vehicle compartment. As a result, it is possible to perform an air-conditioning of the vehicle compartment.

Furthermore, it is possible to cool the battery 80 by making the low temperature side thermal medium cooled by the chiller 19 to flow into the cooling heat exchange unit 52.

(6) Series Dehumidifying, Heating and Cooling Mode

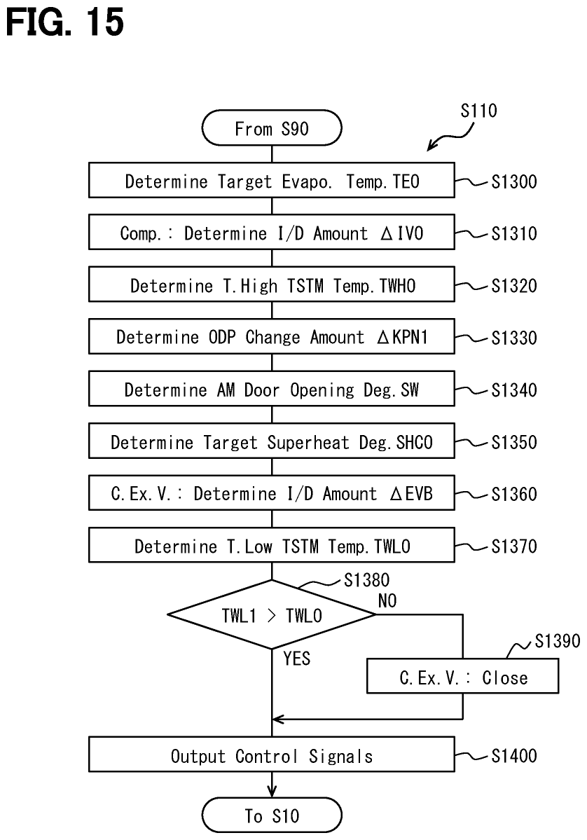

In the series dehumidifying, heating and cooling mode, the control unit 60 executes the control flow in the series dehumidifying, heating and cooling mode shown in FIG. 15. First, in steps S1300 to S1340, the target evaporator temperature TEO, the increase/decrease amount ΔIVO of the rotation speed of the compressor 11, the change amount ΔKPN1 of the opening degree pattern KPN1, and the opening degree SW of the air-mix door 34 is determined similar to steps S700 to S740 in the series dehumidifying and heating mode,

In subsequent steps S1350 to S1370, the target superheat degree SHCO, the increase/decrease amount ΔEVB of the orifice opening degree of the cooling expansion valve 14c, and the target low temperature side thermal medium temperature TWLO are determined similar to steps S1150 to S1170 in the air-conditioning and cooling mode.

Next, in step S1380, if it is determined that the first low temperature side thermal medium temperature TWL1 is higher than the target low temperature side thermal medium temperature TWLO, the process proceeds to step S1400 similar to the air-conditioning and cooling mode. When it is not determined in step S1380 that the first low temperature side thermal medium temperature TWL1 is higher than the target low temperature side thermal medium temperature TWLO, the process proceeds to step S1390. In step S1390, the cooling expansion valve 14c is fully closed and the process proceeds to step S1400.

In step S1400, the refrigeration cycle device 10 is switched to the refrigerant circuit in the series dehumidifying, heating and cooling mode. Specifically, the dehumidifying on-off valve 15a is closed, and the heating on-off valve 15b is closed. Furthermore, control signals or control voltages are output to each control object device so that the control state determined in steps S1310, S1330, S1340, S1360 and S1390 is obtained, and the process returns to step S10.

Therefore, in the series dehumidifying, heating and cooling mode, a steam compression type refrigeration cycle is configured, wherein the refrigerant circulates in an order of the compressor 11, the water-refrigerant heat exchanger 12, the heating expansion valve 14a, the outdoor heat exchanger 16, the check valve 17, the air-conditioning expansion valve 14b, the indoor evaporator 18, the evaporation pressure regulating valve 20, the accumulator 21, and the compressor 11, and simultaneously the refrigerant circulates in an order of the compressor 11, the water-refrigerant heat exchanger 12, the heating expansion valve 14a, the outdoor heat exchanger 16, the check valve 17, the cooling expansion valve 14c, the chiller 19, the evaporation pressure regulating valve 20, the accumulator 21, and the compressor 11.

That is, in the refrigeration cycle apparatus 10 in the series dehumidifying, heating and cooling mode, a steam compression type refrigeration cycle is configured in which the water-refrigerant heat exchanger 12 functions as a radiator, and the indoor evaporator 18 and the chiller 19 function as evaporators.

Further, when the saturation temperature of the refrigerant in the outdoor heat exchanger 16 is higher than the outside air temperature Tam, the cycle in which the outdoor heat exchanger 16 functions as a radiator is configured. Further, when the saturation temperature of the refrigerant in the outdoor heat exchanger 16 is lower than the outside air temperature Tam, the cycle in which the outdoor heat exchanger 16 functions as an evaporator is configured.

According to this, the blown air can be cooled at the indoor evaporator 18, and simultaneously the high temperature side thermal medium can be heated at the water-refrigerant heat exchanger 12. Further, the chiller 19 can cool a low pressure side thermal medium.

Therefore, in the refrigerant cycle device 10 in the series dehumidifying, heating and cooling mode, it is possible to perform a dehumidifying and heating of the vehicle compartment by discharging the blown air which is cooled and dehumidified by the indoor evaporator 18, and is reheated by the heater core 42 into the vehicle compartment. At this time, by increasing the opening degree pattern KPN1, it is possible to improve the heating capacity of the blower air in the heater core 42 similar to the serial dehumidifying and heating mode.

Furthermore, it is possible to cool the battery 80 by making the low temperature side thermal medium cooled by the chiller 19 to flow into the cooling heat exchange unit 52.

(7) Parallel Dehumidifying, Heating and Cooling Mode

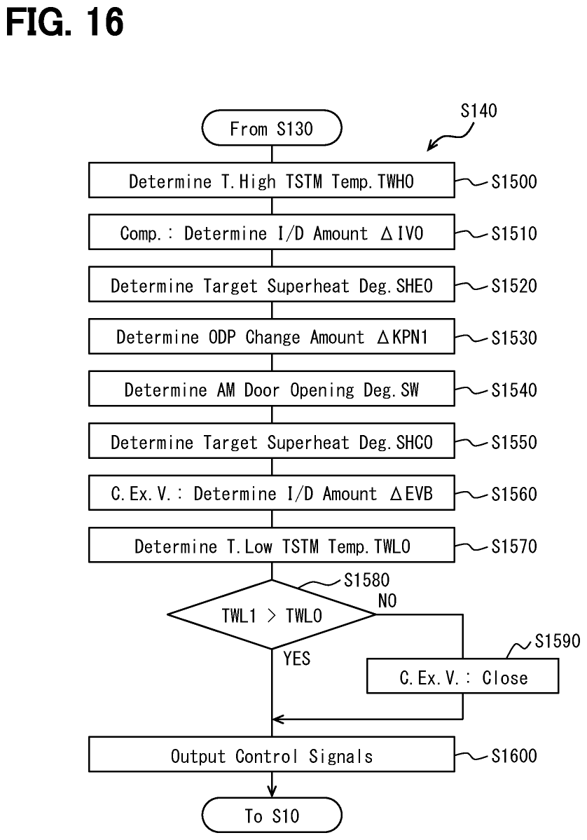

In the parallel dehumidifying, heating and cooling mode, the control unit 60 executes the control flow in the parallel dehumidifying, heating and cooling mode shown in FIG. 16. First, in steps S1500 to S1540, the target high temperature side thermal medium temperature TWHO, the increase/decrease amount ΔIVO of the rotation speed of the compressor 11, the target superheat degree SHEO, the change amount ΔKPN1 of the opening degree pattern KPN1, and the opening degree SW of the air-mix door 34 are determined similar to steps S800 to S840 in the parallel dehumidifying and heating mode.

In subsequent steps S1550 to S1570, the target superheat degree SHCO, the increase/decrease amount ΔEVB of the orifice opening degree of the cooling expansion valve 14c, and the target low temperature side thermal medium temperature TWLO are determined similar to steps S1150 to S1170 in the air-conditioning and cooling mode.

Next, in step S1580, if it is determined that the first low temperature side thermal medium temperature TWL1 is higher than the target low temperature side thermal medium temperature TWLO, the process proceeds to step S1600 similar to the air-conditioning and cooling mode. When it is not determined in step S1580 that the first low temperature side thermal medium temperature TWL1 is higher than the target low temperature side thermal medium temperature TWLO, the process proceeds to step S1590. In step S1590, the cooling expansion valve 14c is fully closed and the process proceeds to step S1600.

In step S1600, the refrigeration cycle device 10 is switched to the refrigerant circuit in the parallel dehumidifying, heating and cooling mode. Specifically, the dehumidifying on-off valve 15a is opened, and the heating on-off valve 15b is opened. Furthermore, control signals or control voltages are output to each control object device so that the control state determined in steps S1510, S1530, S1540, S1560 and S1590 is obtained, and the process returns to step S10.

Therefore, in the refrigeration cycle device 10 in the parallel dehumidifying, heating and cooling mode, a steam compression type refrigeration cycle is configured, wherein the refrigerant circulates in an order of the compressor 11, the water-refrigerant heat exchanger 12, the heating expansion valve 14a, the outdoor heat exchanger 16, the heating passage 22b, the accumulator 21, and the compressor 11, and simultaneously the refrigerant circulates in an order of the compressor 11, the water-refrigerant heat exchanger 12, the bypass passage 22a, the air-conditioning expansion valve 14b, the indoor evaporator 18, the evaporation pressure regulating valve 20, the accumulator 21, and the compressor 11, and further the refrigerant circulates in an order of the compressor 11, the water-refrigerant heat exchanger 12, the bypass passage 22a, the cooling expansion valve 14c, the chiller 19, the evaporation pressure regulating valve 20, the accumulator 21, and the compressor 11.

That is, in the refrigeration cycle device 10 in the parallel dehumidifying, heating and cooling mode, a refrigeration cycle is configured in which the water-refrigerant heat exchanger 12 functions as a radiator, and the outdoor heat exchanger 16, the indoor evaporator 18 and the chiller 19 function as evaporators.

According to this, the blown air can be cooled at the indoor evaporator 18, and simultaneously the high temperature side thermal medium can be heated at the water-refrigerant heat exchanger 12. Further, the chiller 19 can cool a low pressure side thermal medium.

Therefore, in the vehicle air-conditioner 1 in the parallel dehumidifying, heating and cooling mode, it is possible to perform a dehumidifying and heating of the vehicle compartment by discharging the blown air which is cooled and dehumidified by the indoor evaporator 18, and is reheated by the heater core 42 into the vehicle compartment. At this time, it is possible to reheat the blown air with a heating capacity higher than that in the series dehumidifying, heating and cooling mode by lowering the refrigerant evaporation temperature in the outdoor heat exchanger 16 below the refrigerant evaporation temperature in the indoor evaporator 18.

Furthermore, it is possible to cool the battery 80 by making the low temperature side thermal medium cooled by the chiller 19 to flow into the cooling heat exchange unit 52.

(8) Heating and Cooling Mode

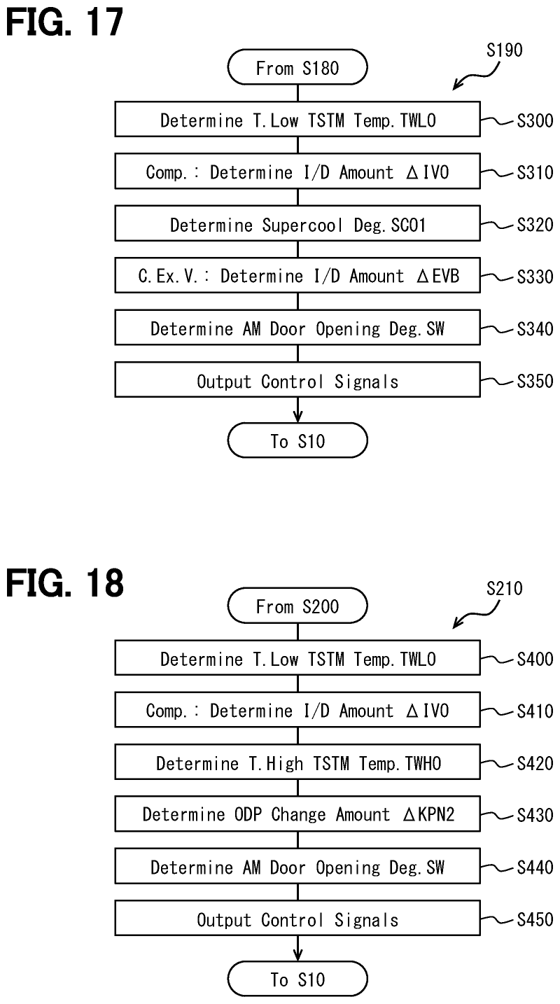

In the heating and cooling mode, the control unit 60 executes the control flow in the heating and cooling mode shown in FIG. 17. First, in step S300, the target low temperature side thermal medium temperature TWLO of the low temperature side thermal medium is determined so that the battery 80 can be cooled by the cooling heat exchange unit 52.

In the heating and cooling mode, the target low temperature side thermal medium temperature TWLO of the low temperature side thermal medium is determined to be higher than that in the air-conditioning and cooling mode.

Specifically, the target low temperature side thermal medium temperature TWLO is determined by the second fixed value TWLO2 stored in advance in the control unit 60. As shown in FIG. 23, the second fixed value TWLO2 is a value larger than the first fixed value TWLO1.

In step S310, the increase/decrease amount ΔIVO of the rotation speed of the compressor 11 is determined. In the heating and cooling mode, the increase/decrease amount ΔIVO is determined so that the first low temperature side thermal medium temperature TWL1 approaches the target low temperature thermal medium temperature TWLO, by the feedback control method, based on a deviation between the target low temperature side thermal medium temperature TWLO and the first low temperature side thermal medium temperature TWL1.

In step S320, the target sub-cool degree SCO1 of the refrigerant flowing out of the outdoor heat exchanger 16 is determined. The target sub-cool degree SCO1 is determined by referring to the control map, for example, based on the outside air temperature Tam. In the control map of this embodiment, the target sub-cool degree SCO1 is determined so that the coefficient of performance (COP) of the cycle approaches the maximum value.

In step S330, the increase/decrease amount ΔEVB of the orifice opening degree of the cooling expansion valve 14c is determined. The increase/decrease amount ΔEVB is determined so that the sub-cool degree SC1 of the refrigerant on the outlet side of the outdoor heat exchanger 16 approaches the target sub-cool degree SCO1, by the feedback control method, based on a deviation between the target sub-cool degree SCO1 and the sub-cool degree SC1 of the refrigerant on the outlet side of the outdoor heat exchanger 16. The sub-cool degree SC1 is calculated similar to the air-conditioning mode.

In step S340, the opening degree SW of the air-mix door 34 is calculated similar to the air-conditioning mode.

In step S350, the refrigeration cycle device 10 is switched to a refrigerant circuit in the heating and cooling mode. Specifically, the heating expansion valve 14a is fully opened, the air-conditioning expansion valve 14b is fully closed, the dehumidifying on-off valve 15a is closed, and the heating on-off valve 15b is closed. Furthermore, control signals or control voltages are output to each control object device so that the control state determined in steps S310, S330, and S340 is obtained, and the process returns to step S10.

Therefore, in the refrigeration cycle device 10 in the heating and cooling mode, a steam compression type refrigeration cycle is configured, wherein the refrigerant circulates in an order of the compressor 11, the water-refrigerant heat exchanger 12, the heating expansion valve 14a, the outdoor heat exchanger 16, the check valve 17, the cooling expansion valve 14c, the chiller 19, the evaporation pressure regulating valve 20, the accumulator 21, and the compressor 11.

That is, in the refrigerating cycle device 10 in the heating and cooling mode, a steam compression type refrigerating cycle is configured in which the water-refrigerant heat exchanger 12 and the outdoor heat exchanger 16 function as radiators and the chiller 19 functions as an evaporator.

According to this, the high temperature side thermal medium can be heated at the water-refrigerant heat exchanger 12 and simultaneously the low temperature side thermal medium can be cooled at the chiller 19.

Therefore, in the vehicle air-conditioner 1 in the heating and cooling mode, it is possible to perform a heating of the vehicle compartment by discharging the blown air which is heated by the heater core 42 into the vehicle compartment. Furthermore, it is possible to cool the battery 80 by making the low temperature side thermal medium cooled by the chiller 19 to flow into the cooling heat exchange unit 52.

(9) Series Heating and Cooling Mode

In the series heating and cooling mode, the control unit 60 executes the control flow of the series heating and cooling mode shown in FIG. 18. First, in step S400, the target low temperature side thermal medium temperature TWLO is determined in the same manner similar to the air-conditioning and cooling mode. That is, the target low temperature side thermal medium temperature TWLO is determined to be the first fixed value TWLO1 stored in advance in the control unit 60.

In step S410, the increase/decrease amount ΔIVO of the rotation speed of the compressor 11 is determined similar to the heating and cooling mode.

In step S420, the target high temperature side thermal medium temperature TWHO of the high temperature side thermal medium is determined similar to the series dehumidifying and heating mode.

In step S430, a change amount ΔKPN2 (Delta-KPN2) of the opening pattern KPN2 is determined. The opening degree pattern KPN2 is a parameter for determining a combination of the orifice opening degree of the heating expansion valve 14a and the orifice opening degree of the cooling expansion valve 14c.

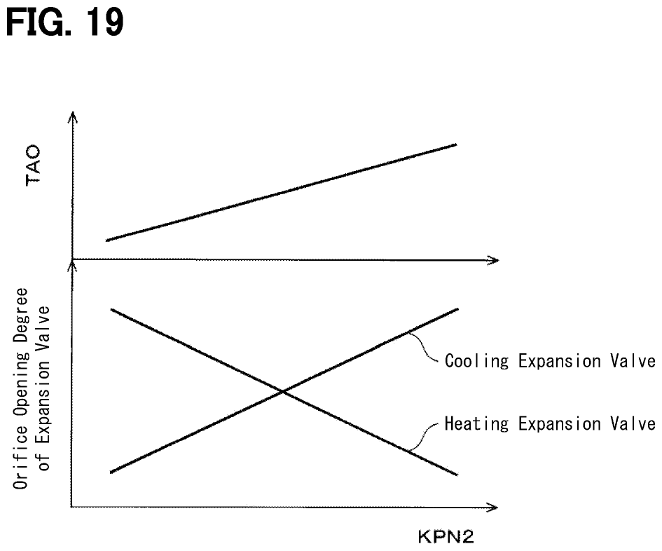

Specifically, in the series dehumidifying and cooling mode, as shown in FIG. 19, the opening degree pattern KPN2 gets great, as the target outlet temperature TAO increases. As the opening degree pattern KPN2 getting great, the orifice opening degree of the heating expansion valve 14a decreases, and the orifice opening degree of the cooling expansion valve 14c increases.

In step S440, the opening degree SW of the air-mix door 34 is calculated similar to the air-conditioning mode.

In step S450, the refrigeration cycle device 10 is switched to a refrigerant circuit in the series heating and cooling mode. Specifically, the air-conditioning expansion valve 14b is fully closed, the dehumidifying on-off valve 15a is closed, and the heating on-off valve 15b is closed. Furthermore, control signals or control voltages are output to each control object device so that the control state determined in steps S310, S330, and S340 is obtained, and the process returns to step S10.

Therefore, in the refrigeration cycle device 10 in the series heating and cooling mode, a steam compression type refrigeration cycle is configured, wherein the refrigerant circulates in an order of the compressor 11, the water-refrigerant heat exchanger 12, the heating expansion valve 14a, the outdoor heat exchanger 16, the check valve 17, the cooling expansion valve 14c, the chiller 19, the evaporation pressure regulating valve 20, the accumulator 21, and the compressor 11.

That is, in the refrigeration cycle device 10 in the series heating and cooling mode, a vapor compression refrigeration cycle is configured in which the water-refrigerant heat exchanger 12 functions as a radiator and the chiller 19 functions as an evaporator.

Further, when the saturation temperature of the refrigerant in the outdoor heat exchanger 16 is higher than the outside air temperature Tam, the cycle in which the outdoor heat exchanger 16 functions as a radiator is configured. Further, when the saturation temperature of the refrigerant in the outdoor heat exchanger 16 is lower than the outside air temperature Tam, the cycle in which the outdoor heat exchanger 16 functions as an evaporator is configured.

According to this, the high temperature side thermal medium can be heated at the water-refrigerant heat exchanger 12 and simultaneously the low temperature side thermal medium can be cooled at the chiller 19.

Therefore, in the vehicle air-conditioner 1 in the series heating and cooling mode, it is possible to perform a heating of the vehicle compartment by discharging the blown air which is heated by the heater core 42 into the vehicle compartment. Furthermore, it is possible to cool the battery 80 by making the low temperature side thermal medium cooled by the chiller 19 to flow into the cooling heat exchange unit 52.

Furthermore, when the saturation temperature of the refrigerant in the outdoor heat exchanger 16 is higher than the outside air temperature Tam, the opening degree pattern KPN2 is increased in accordance with the increase in the target outlet temperature TAO, thereby the saturation temperature of the refrigerant in the outdoor heat exchanger 16 is lowered to reduce a difference to the outside air temperature Tam. Thereby, it is possible to increase a heat dissipation amount form the refrigerant in the water-refrigerant heat exchanger 12 by reducing a heat dissipation amount from the refrigerant in the outdoor heat exchanger 16.

Furthermore, when the saturation temperature of the refrigerant in the outdoor heat exchanger 16 is lower than the outside air temperature Tam, the opening degree pattern KPN2 is increased in accordance with the increase in the target outlet temperature TAO, thereby the saturation temperature of the refrigerant in the outdoor heat exchanger 16 is lowered to expand a difference to the outside air temperature Tam. As a result, it is possible to increase a heat dissipation amount form the refrigerant in the water-refrigerant heat exchanger 12 by increasing a heat absorption amount to the refrigerant in the outdoor heat exchanger 16.

That is, in the series heating and cooling mode, it is possible to increase the heat dissipation amount from the refrigerant to the high temperature side thermal medium in the water-refrigerant heat exchanger 12 by increasing the opening degree pattern KPN2 as the target outlet temperature TAO increases. Therefore, in the series heating and cooling mode, it is possible to improve the heating capacity of the blown air in the heater core 42 as the target outlet temperature TAO increases.

(10) Parallel Heating and Cooling Mode

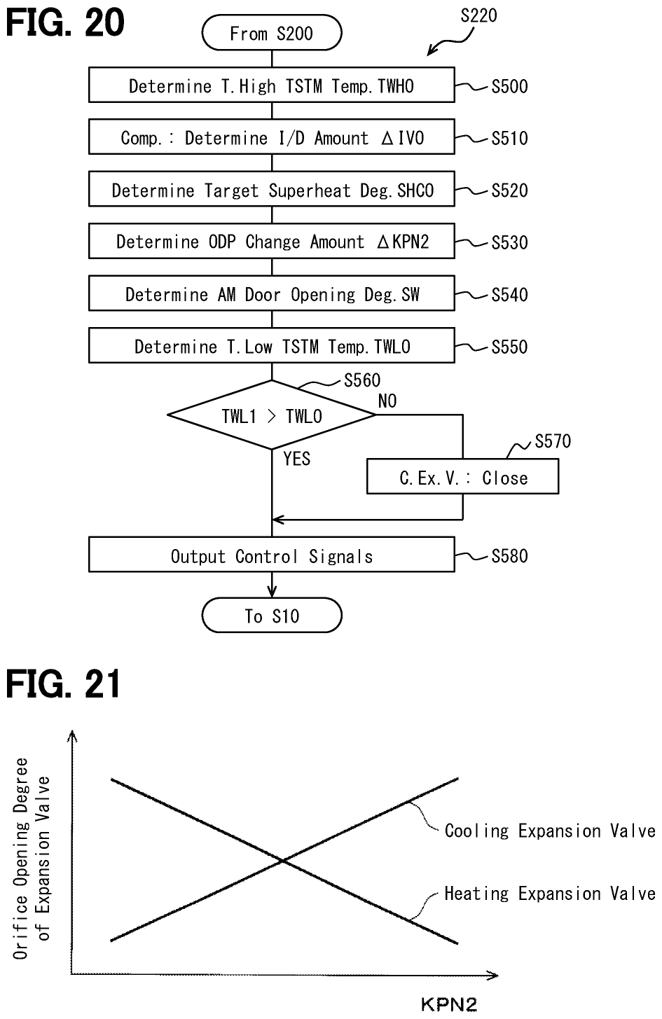

In the parallel heating and cooling mode, the control unit 60 executes the control flow of the parallel heating and cooling mode shown in FIG. 20. First, in step S500, the target high temperature side thermal medium temperature TWHO of the high temperature side thermal medium is determined similar to the series dehumidifying and heating mode in order to heat the blown air at the heater core 42.

In step S510, the increase/decrease amount ΔIVO of the rotation speed of the compressor 11 is determined. In the parallel heating and cooling mode, the increase/decrease amount ΔIVO is determined so that the high temperature side thermal medium temperature TWH approaches the target high temperature side thermal medium temperature TWHO, by the feedback control method, based on a deviation between the target high temperature side thermal medium temperature TWHO and the high temperature side thermal medium temperature TWH, similar to the parallel dehumidifying and heating mode.

In step S520, the target superheat degree SHCO of the refrigerant on the outlet side of the refrigerant passage of the chiller 19 is determined. A predetermined constant (5° C. in this embodiment) may be adopted as the target superheat degree SHCO.

In step S530, a change amount ΔKPN2 of the opening pattern KPN2 is determined. In the parallel heating and cooling mode, the superheat degree SHC is determined to approach the target superheat degree SHCO, by the feedback control method, based on a deviation between the target superheat degree SHCO and the superheat degree SHC of the refrigerant on the outlet side of the chiller 19.

Further, in the parallel heating and cooling mode, as shown in FIG. 21, as the opening degree pattern KPN2 getting great, the orifice opening degree of the heating expansion valve 14a decreases, and the orifice opening degree of the cooling expansion valve 14c increases. Therefore, when the opening degree pattern KPN2 increases, the flow amount of the refrigerant flowing into the refrigerant passage of the chiller 19 increases, and the superheat degree SHC of the refrigerant on the outlet side of the refrigerant passage of the chiller 19 decreases.

In step S540, the opening degree SW of the air-mix door 34 is calculated similar to the air-conditioning mode. In step S550, the target low temperature side thermal medium temperature TWLO of the low temperature side thermal medium is determined similar to the air-conditioning and cooling mode. That is, the target low temperature side thermal medium temperature TWLO is determined to be the first fixed value TWLO1 stored in advance in the control unit 60.

In step S560, it is determined whether the first low temperature side thermal medium temperature TWL1 detected by the first low temperature side thermal medium temperature sensor 67a is higher than the target low temperature side thermal medium temperature TWLO.

If it is determined in step S560 that the first low temperature side thermal medium temperature TWL1 is higher than the target low temperature side thermal medium temperature TWLO, the process proceeds to step S580, and if it is not determined that the first low temperature side thermal medium temperature TWL1 is higher than the target low temperature side thermal medium temperature TWLO, the process proceeds to step S570. In step S570, the cooling expansion valve 14c is fully closed and the process proceeds to step S580.

In step S580, in order to switch the refrigeration cycle device 10 to a refrigerant circuit in the parallel heating and cooling mode, the air-conditioning expansion valve 14b is fully closed, the dehumidifying on-off valve 15a is opened, and the heating on-off valve 15b is opened. Furthermore, control signals or control voltages are output to each control object device so that the control state determined in steps S510, S530, S540 and S570 is obtained, and the process returns to step S10.

Therefore, in the refrigeration cycle device 10 in the parallel heating and cooling mode, a steam compression type refrigeration cycle is configured, wherein the refrigerant circulates in an order of the compressor 11, the water-refrigerant heat exchanger 12, the heating expansion valve 14a, the outdoor heat exchanger 16, the heating passage 22b, the accumulator 21, and the compressor 11, and simultaneously the refrigerant circulates in an order of the compressor 11, the water-refrigerant heat exchanger 12, the bypass passage 22a, the cooling expansion valve 14c, the chiller 19, the evaporation pressure regulating valve 20, the accumulator 21, and the compressor 11.

That is, in the refrigeration cycle device 10 in the parallel heating and cooling mode, the water-refrigerant heat exchanger 12 functions as a radiator, and the outdoor heat exchanger 16 and the chiller 19 connected in parallel to the refrigerant flow function as evaporators.

According to this, the high temperature side thermal medium can be heated at the water-refrigerant heat exchanger 12 and simultaneously the low temperature side thermal medium can be cooled at the chiller 19.

Therefore, in the vehicle air-conditioner 1 in the parallel heating and cooling mode, it is possible to perform a heating of the vehicle compartment by discharging the blown air which is heated by the heater core 42 into the vehicle compartment. Furthermore, it is possible to cool the battery 80 by making the low temperature side thermal medium cooled by the chiller 19 to flow into the cooling heat exchange unit 52.

Further, in the refrigeration cycle apparatus 10 in the parallel heating and cooling mode, the outdoor heat exchanger 16 and the chiller 19 are connected in parallel to the refrigerant flow, and the evaporation pressure regulating valve 20 is arranged on the downstream side of the refrigerant passage of the chiller 19. Thereby, the refrigerant evaporation temperature in the outdoor heat exchanger 16 can be made lower than the refrigerant evaporation temperature in the refrigerant passage of the chiller 19.

Therefore, in the parallel heating and cooling mode, the heat absorption amount of the refrigerant in the outdoor heat exchanger 16 can be increased more than that in the series heating and cooling mode, and the heat dissipation amount of the refrigerant in the water-refrigerant heat exchanger 12 can be increased. As a result, in the parallel heating and cooling mode, the blown air can be reheated with a heating capacity higher than that in the series heating and cooling mode.

(11) Cooling Mode

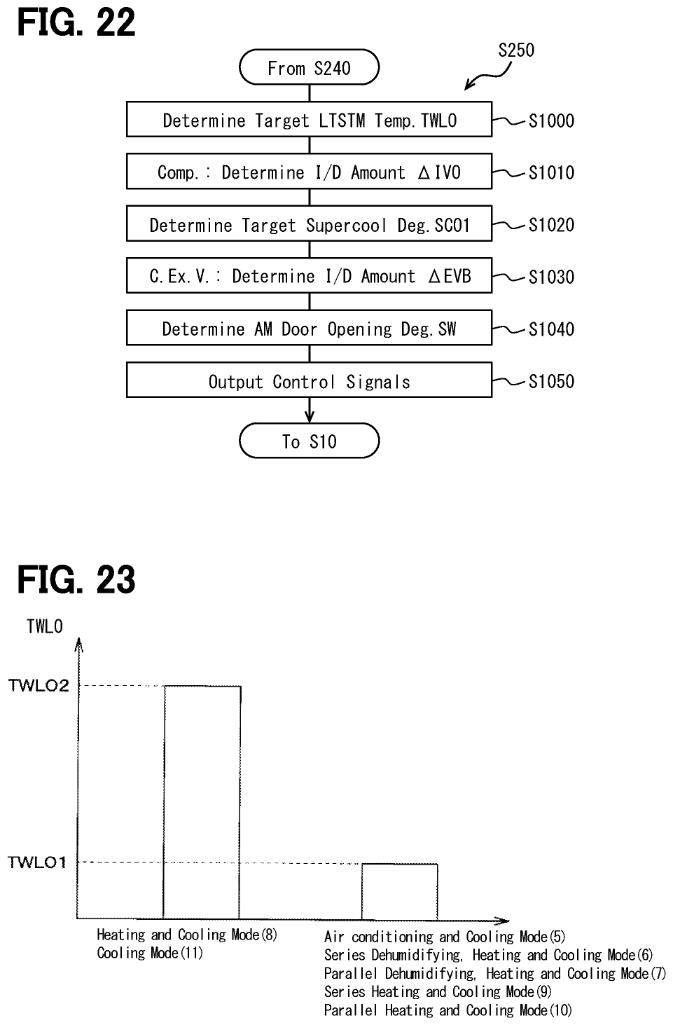

In the cooling mode, the control unit 60 executes the control flow of the cooling mode shown in FIG. 22. First, in steps S1000 to S1040, the increase/decrease amount ΔIVO of the rotation speed of the compressor 11, the target sub-cool degree SCO1, the increase/decrease amount ΔEVB of the orifice opening degree of the cooling expansion valve 14c, and the opening SW of the air-mix door 34 are determined similar to steps S300 to S340 of the heating and cooling mode.

In the cooling mode, the target low temperature side thermal medium temperature TWLO of the low temperature side thermal medium is determined similar to the air-conditioning and cooling mode. That is, the target low temperature side thermal medium temperature TWLO is determined to be the second fixed value TWLO2 stored in advance in the control unit 60. As shown in FIG. 23, the second fixed value TWLO2 is a value larger than the first fixed value TWLO1.

Here, in the cooling mode, since the target outlet temperature TAO becomes lower than the heating reference temperature γ, the opening degree SW of the air-mix door 34 approaches 0%. Therefore, in the cooling mode, the opening degree of the air-mix door 34 is determined so that almost the entire flow amount of the blown air after passing through the indoor evaporator 18 passes through the cold air bypass passage 35.

In step S1050, the refrigeration cycle device 10 is switched to a refrigerant circuit in the cooling mode. Specifically, the heating expansion valve 14a is fully opened, the air-conditioning expansion valve 14b is fully closed, the dehumidifying on-off valve 15a is closed, and the heating on-off valve 15b is closed. Furthermore, control signals or control voltages are output to each control object device so that the control state determined in steps S1010, S1030, and S1040 is obtained, and the process returns to step S10.

Therefore, in the refrigeration cycle device 10 in the air-conditioning mode, a steam compression type refrigeration cycle is configured, wherein the refrigerant circulates in an order of the compressor 11, the water-refrigerant heat exchanger 12, the heating expansion valve 14a, the outdoor heat exchanger 16, the check valve 17, the cooling expansion valve 14c, the chiller 19, the evaporation pressure regulating valve 20, the accumulator 21, and the compressor 11.

That is, in the refrigeration cycle device 10 in the cooling mode, a steam compression type refrigeration cycle is configured in which the outdoor heat exchanger 16 functions as a radiator and the chiller 19 functions as an evaporator. According to this, the chiller 19 can cool the low temperature side thermal medium. Therefore, in the vehicle air-conditioner 1 in the cooling mode, it is possible to cool the battery 80 by making the low temperature side thermal medium cooled by the chiller 19 to flow into the cooling heat exchange unit 52.

As described above, in the refrigeration cycle device 10 of this embodiment, various operation modes can be switched. As a result, in the vehicle air-conditioning device 1, it is possible to perform a comfortable air-conditioning of the vehicle compartment and appropriate temperature adjusting of the battery 80.

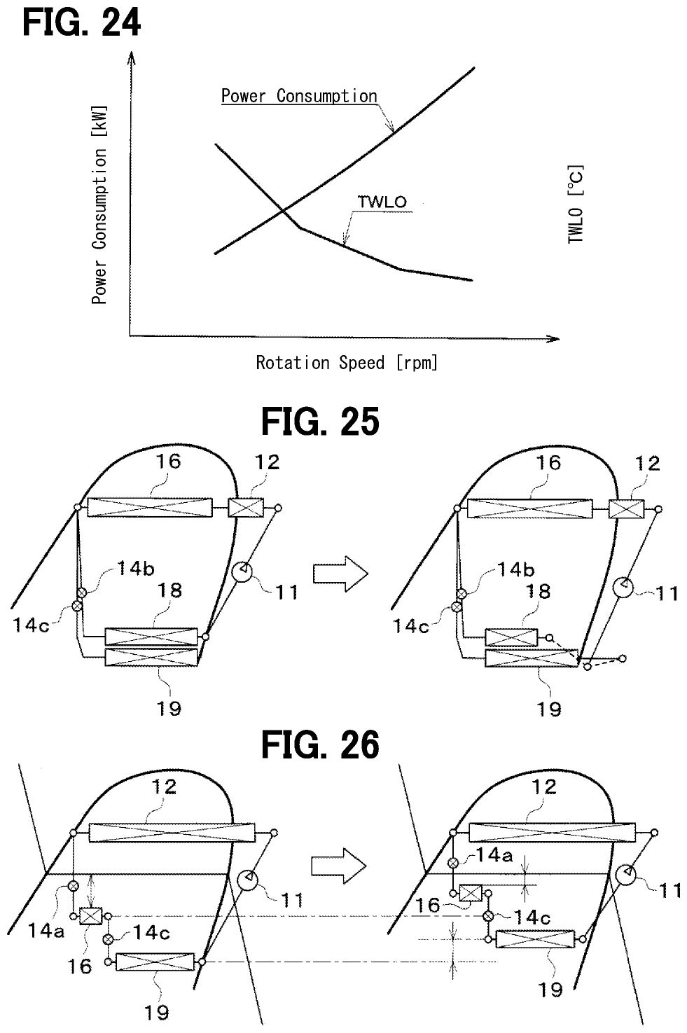

As described above, in the heating and cooling mode (8) and the cooling mode (11), the target low temperature side thermal medium temperature TWLO is set higher than that in the other operation modes. As a result, power saving can be achieved as shown in FIG. 24. The reason will be described below.

As described above, in the heating and cooling mode (8) and the cooling mode (11), the increase/decrease amount ΔIVO of the rotation speed of the compressor 11 is determined so that the first low temperature side thermal medium temperature TWL1 approaches the target low temperature side thermal medium temperature TWLO, by the feedback control method, based on a deviation between the target low temperature side thermal medium temperature TWLO and the first low temperature side thermal medium temperature TWL1.

Therefore, since a rotation speed of the compressor 11 can be kept low by setting the target low temperature side thermal medium temperature TWLO high, so that the power consumption of the compressor 11 can be kept low.

Since the low temperature side thermal medium circulates in the low temperature side thermal medium circuit 50, even if the refrigerant temperature in the chiller 19 increases due to a low rotation speed of the compressor 11, it is possible to secure a temperature difference between the refrigerant and the low temperature side thermal medium in the chiller 19. Therefore, it is possible to secure a cooling capacity of the low temperature side thermal medium in the chiller 19. In other words, it is possible to secure a cooling capacity of the battery 80.

On the other hand, in other operation modes, even if the target low temperature side thermal medium temperature TWLO is set high as in the heating and cooling mode (8) and the cooling mode (11), it is impossible to perform power saving. The reason will be described below.

For example, in the air-conditioning and cooling mode (5), the increase/decrease amount ΔIVO of the rotation speed of the compressor 11 is determined so that the evaporator temperature Tefin approaches the target evaporator temperature TEO, by the feedback control method, based on a deviation between the target evaporator temperature TEO and the evaporator temperature Tefin.

Therefore, if the target low temperature side thermal medium temperature TWLO is set high in the air-conditioning and cooling mode (5), the first low temperature side thermal medium temperature TWL1 is increased by reducing the refrigerant flow amount in the chiller 19. Then, as shown in FIG. 25, a refrigerant state at the outlet of the chiller 19 becomes a superheated gas state, and a refrigerant state at the outlet of the indoor evaporator 18 contrarily becomes a wet state.

As a result, since it is used under condition where the heat exchange efficiency and the cycle balance are poor, therefore, it is impossible to achieve a reduction effect of the power consumption.

For example, in the series heating and cooling mode (9), the chiller 19 cools the low temperature side thermal medium, and simultaneously the water-refrigerant heat exchanger 12 heats the high temperature side thermal medium for heating. As a heat source for heating at this time, heat is absorbed from the outside air by the outdoor heat exchanger 16.

Therefore, as shown in FIG. 26, if the target low temperature side thermal medium temperature TWLO is set high in the series heating and cooling mode (9), the refrigerant temperature in the chiller 19 increases, and simultaneously the refrigerant temperature in the outdoor heat exchanger 16 increases, adversely. As a result, due to decrease an amount of heat absorbed from the outside air by the outdoor heat exchanger 16, a heating capacity is lowered, adversely.

In the present embodiment, the control unit 60 sets the target low temperature side thermal medium temperature TWLO higher in the heating and cooling mode (8) and the cooling mode (11) than in the other operation modes.

According to this, the compressor 11 is controlled so that a temperature of the chiller 19 becomes high. Therefore, a power consumption of the compressor 11 can be reduced.

Since the chiller 19 absorbs heat from the thermal medium circulating between the battery cell 81 to evaporate the refrigerant, even if a temperature of the chiller 19 increased, it is possible to secure a cooling capacity of the thermal medium or the battery cell 81 by securing a temperature difference between the refrigerant in the chiller 19 and the thermal medium or the battery cell 81.

Since the target low temperature side thermal medium temperature TWLO in the other modes is set lower than that in the heating and cooling mode (8) and the cooling mode (11), it is possible to suppress lowing of power consumption on the compressor 11 which may be caused by using in a state where the heat exchange efficiency and the cycle balance are poor (see FIGS. 25 to 26 described above).

In the present embodiment, in the heating and cooling mode (8) and the cooling mode (11), the control unit 60 controls the air-conditioning expansion valve 14b, the cooling expansion valve 14c, the heating expansion valve 14a, the heating on-off valve 15b, and the dehumidifying on-off valve 15a so that the refrigerant dissipates heat on at least one of the water-refrigerant heat exchanger 12 and the outdoor heat exchanger 16, the refrigerant evaporates at the chiller 19, and the refrigerant does not evaporate at the indoor evaporator 18.

Further, in other operation modes, the control unit 60 controls the air-conditioning expansion valve 14b, the cooling expansion valve 14c, the heating expansion valve 14a, the heating on-off valve 15b, and the dehumidifying on-off valve 15a so that the refrigerant evaporates at the chiller 19 and the refrigerant evaporates on at least one of the outdoor heat exchanger 16 and the evaporator 18.

Thereby, the above-mentioned action and effect can be obtained in the refrigeration cycle device capable of performing the air-conditioning, the heating and the dehumidifying and heating.

In the present embodiment, the heating and cooling mode (8) is a heating and cooling mode, wherein the refrigerant dissipates heat in the water-refrigerant heat exchanger 12 and the outdoor heat exchanger 16, the refrigerant evaporates in the chiller 19, and the refrigerant does not flow in the evaporator 18.

Further, the cooling mode (11) is a cooling mode, wherein the refrigerant does not dissipate heat in the water-refrigerant heat exchanger 12, the refrigerant dissipates heat in the outdoor heat exchanger 16, the refrigerant evaporates in the chiller 19, and the refrigerant does not flow in the evaporator 18. As a result, the power consumption can be reliably reduced.

In the present embodiment, the control unit 60 controls operation of the compressor 11 and the cooling expansion valve 14c so that a temperature of the thermal medium of which heat is absorbed at the chiller 19 approaches the target low temperature side thermal medium temperature TWLO. As a result, the battery cell 81 can be cooled satisfactorily.

### Second Embodiment

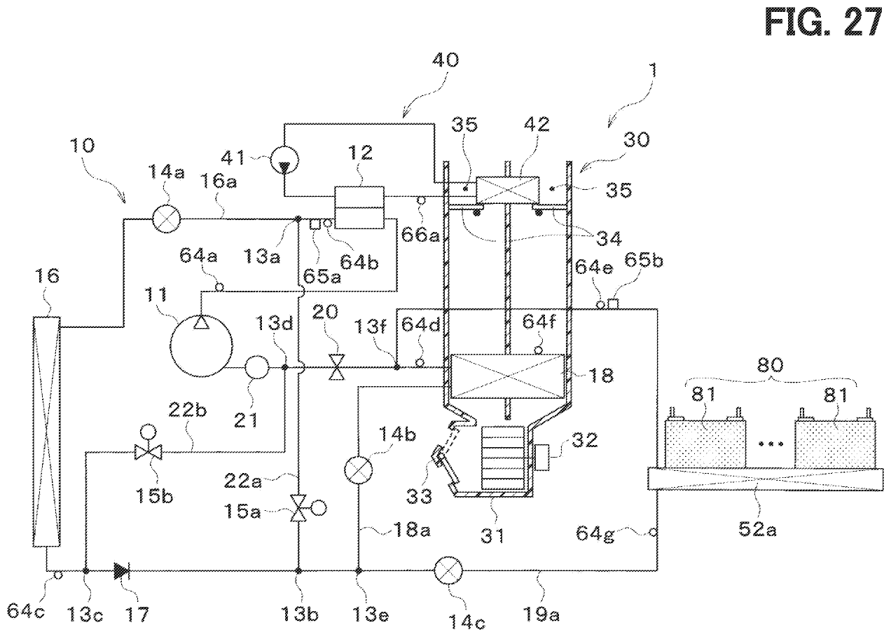

In this embodiment, as shown in FIG. 27, an example in which the low temperature side thermal medium circuit 50 is eliminated with respect to the first embodiment will be described. In FIG. 27, the same or equivalent parts as those of the first embodiment are denoted by the same reference numerals. This also applies to the following drawings.

More specifically, in the refrigeration cycle device 10 of the present embodiment, the inlet side of the cooling heat exchange unit 52a is connected to the outlet of the cooling expansion valve 14c. The cooling heat exchange unit 52a is a so-called direct cooling type cooler to cool the battery 80 by evaporating the refrigerant flowing through the refrigerant passage and making the refrigerant to absorb heat. Therefore, in the present embodiment, the cooling heat exchange unit 52a constitutes a cooling unit.

It is desirable that the cooling heat exchange unit 52a be configured to have a plurality of refrigerant flow paths connected in parallel with each other so that the entire area of the battery 80 can be uniformly cooled. The other inlet of the sixth three-way joint 13f is connected to an outlet of the cooling heat exchange unit 52a.

A cooling heat exchange unit inlet temperature sensor 64g is connected to the inlet side of the control unit 60 of the present embodiment. The cooling heat exchange unit inlet temperature sensor 64g is a cooling heat exchange unit inlet temperature detecting unit that detects a temperature of the refrigerant flowing into the refrigerant passage of the cooling heat exchange unit 52a.

Further, the fifth refrigerant temperature sensor 64e of the present embodiment detects a temperature T5 of the refrigerant flowing out from the refrigerant passage of the cooling heat exchange unit 52a. The second refrigerant pressure sensor 65b of the present embodiment detects a pressure P2 of the refrigerant flowing out from the refrigerant passage of the cooling heat exchange unit 52a.

Further, the control unit 60 of the present embodiment closes the cooling expansion valve 14c when the temperature T7 detected by the cooling heat exchange unit inlet temperature sensor 64g is equal to or lower than the reference inlet side temperature, during an operation mode in which the battery 80 may need cooling, that is, in an operation mode in which the cooling expansion valve 14c may be in an orifice state. This prevents the battery 80 from reducing the output of the battery 80 by being unnecessarily cooled.

Other configurations and operations of the refrigeration cycle device 10 are similar to those of the first embodiment. According to this, advantages similar to that of the first embodiment can be obtained. That is, also in the refrigeration cycle device 10 of the present embodiment, the temperature of the blown air can be continuously adjusted in a wide range while appropriately adjusting the temperature of the battery 80.

### Third Embodiment

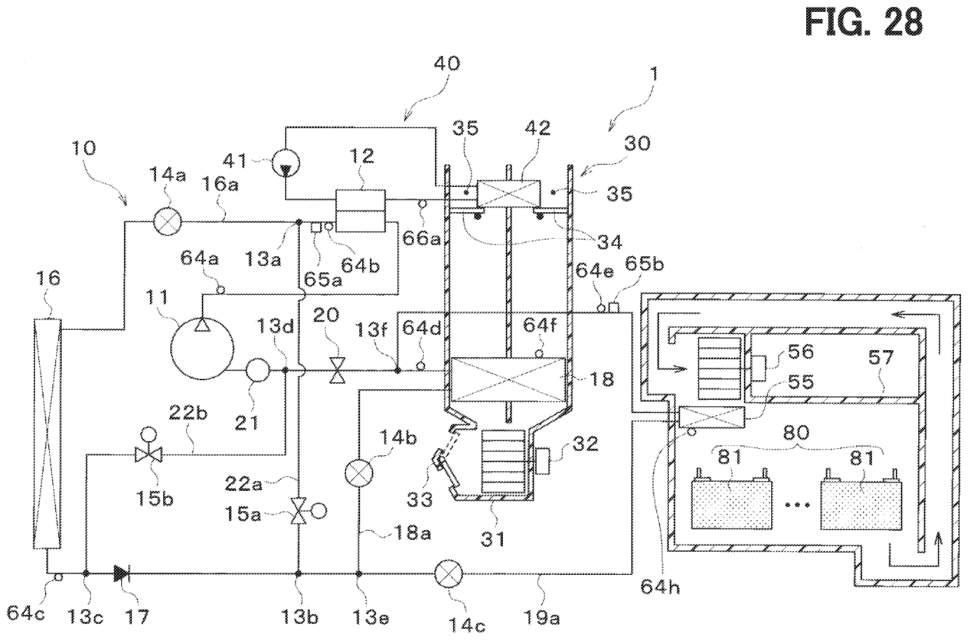

In this embodiment, as shown in FIG. 28, an example, in which the low temperature side thermal medium circuit 50 is removed, and a battery evaporator 55, a battery blower 56, and a battery case 57 are added to the first embodiment, will explain.

More specifically, the battery evaporator 55 is a cooling heat exchanger to cool the cooling blown air by making the refrigerant to absorb heat, by evaporating the refrigerant by performing heat exchange between the refrigerant decompressed by the cooling expansion valve 14c and the cooling blown air blown from the battery blower 56. One inlet of the sixth three-way joint 13f is connected to a refrigerant outlet of the battery evaporator 55.

The battery blower 56 blows the cooling blown air cooled by the battery evaporator 55 toward the battery 80. The battery blower 56 is an electric blower whose rotation speed (blowing capacity) is controlled by a control voltage output from the control unit 60.

The battery case 57 houses the battery evaporator 55, the battery blower 56, and the battery 80, and simultaneously forms an air passage for guiding the cooling blown air blown from the battery blower 56 to the battery 80. The air passage is a circulation passage that guides the cooling air blown to the battery 80 to the suction side of the battery blower 56.

Therefore, in the present embodiment, the battery blower 56 blows the cooling blown air cooled by the battery evaporator 55 onto the battery 80, whereby the battery 80 is cooled. That is, in this embodiment, the battery evaporator 55, the battery blower 56, and the battery case 57 form a cooling unit.

Further, a battery evaporator temperature sensor 64h is connected to the input side of the control unit 60 of the present embodiment. The battery evaporator temperature sensor 64h is a battery evaporator temperature detection unit that detects a refrigerant evaporation temperature (battery evaporator temperature) T7 in the battery evaporator 55. The battery evaporator temperature sensor 64h of the present embodiment specifically detects a heat exchange fin temperature of the battery evaporator 55.

In addition, the control unit 60 of the present embodiment controls the operation of the battery blower 56 so as to exhibit a reference air blowing capacity for each predetermined operation mode regardless of the operation mode.

Further, in the present embodiment, the cooling expansion valve 14c is closed when the temperature T8 detected by the battery evaporator temperature sensor 64h is equal to or lower than the reference battery evaporator temperature, during an operation mode in which the battery 80 may need cooling, that is, in an operation mode in which the cooling expansion valve 14c may be in an orifice state. This prevents the battery 80 from reducing the output of the battery 80 by being unnecessarily cooled.

Other configurations and operations of the refrigeration cycle device 10 are similar to those of the first embodiment. According to this, advantages similar to that of the first embodiment can be obtained.

### Fourth Embodiment

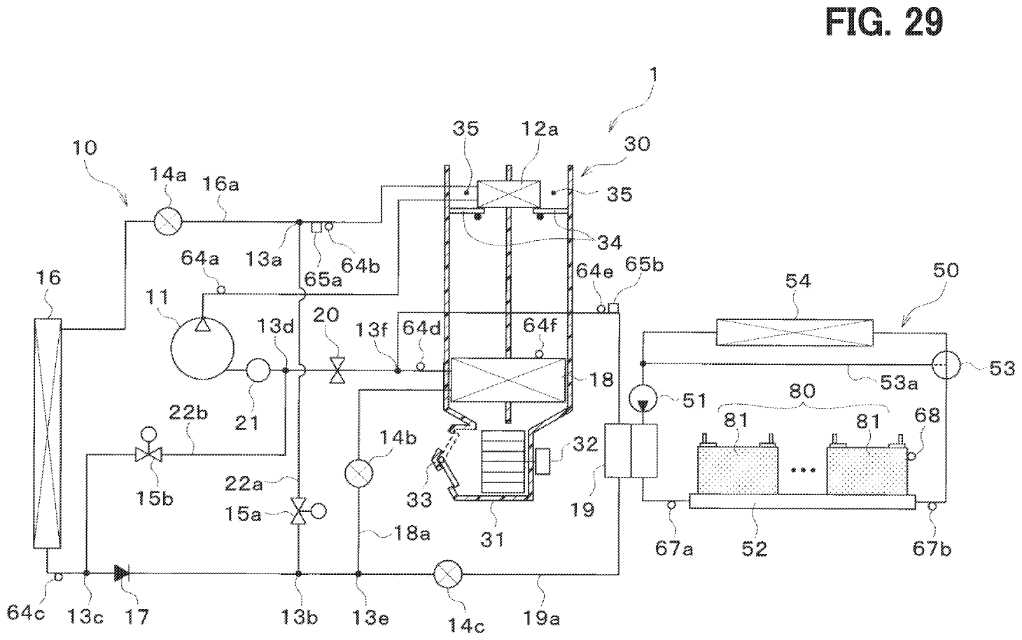

In the present embodiment, as shown in FIG. 29, an example in which the high temperature side thermal medium circuit 40 is eliminated and the indoor condenser 12a is adopted with respect to the first embodiment will be described.

More specifically, the indoor condenser 12a is a heating unit to condense the refrigerant and simultaneously to heat the blown air, by performing heat exchange between the high-temperature high-pressure refrigerant discharged from the compressor 11 and the blown air. The indoor condenser 12a is arranged in the air-conditioning case 31 of the indoor air-conditioning unit 30 similar to the heater core 42 described in the first embodiment.

Other configurations and operations of the refrigeration cycle device 10 are similar to those of the first embodiment. According to this, advantages similar to that of the first embodiment can be obtained.

The present disclosure is not limited to the embodiments described above, and various modifications can be made as follows within a scope not departing from the spirit of the present disclosure.

For example, the indoor condenser 12a described in the fourth embodiment may be adopted as the heating unit of the refrigeration cycle device 10 described in the second and third embodiments.

Although the refrigeration cycle device 10 capable of switching to a plurality of operation modes has been described in the above embodiment, the switching of operation modes of the refrigeration cycle device 10 is not limited to this.

For example, in order to continuously adjust the temperature of the blown air in a wide range while appropriately adjusting the temperature of the cooling object, it is enough to be able to switch at least the series dehumidifying and heating mode (2), the parallel dehumidifying and heating mode (3), the series heating and cooling mode (9), and the parallel heating and cooling mode (10). Desirably, in addition to the four operation modes described above, it may be switched to the operation modes of the air-conditioning mode (1) and the heating and cooling mode (8).

Further, in the above-described embodiment, an example in which the second cooling reference temperature β2 is determined to be higher than the dehumidifying reference temperature β1 has been described, but the second cooling reference temperature β2 and the dehumidifying reference temperature β1 may be set equivalent. Further, although an example in which the first cooling reference temperature α2 is determined to be higher than the air-conditioning reference temperature α1 has been described, the first cooling reference temperature α2 and the air-conditioning reference temperature α1 may be set equivalent.

Further, the detailed control of each operation mode is not limited to the one disclosed in the above-described embodiment. For example, a blowing mode described in step S260 may be a stop mode that stops not only the compressor 11 but also the blower 32.

The components of the refrigeration cycle device are not limited to those disclosed in the above-described embodiment. A plurality of cycle components may be integrated to perform the above-described effects. For example, a joint having a four-way joint structure in which the second three-way joint 13b and the fifth three-way joint 13e are integrated may be adopted. Further, a valve in which an electric expansion valve having no fully closing function and an on-off valve are directly connected may be adopted as the air-conditioning expansion valve 14b and the cooling expansion valve 14c.

In addition, in the embodiments described above, although R1234yf is employed as the refrigerant, the refrigerant is not limited to the above example. For example, R134a, R600a, R410A, R404A, R32, R407C, and the like may be employed. Alternatively, a mixed refrigerant or the like in which multiple types of those refrigerants are mixed together may be employed. Further, carbon dioxide may be employed as the refrigerant to configure a supercritical refrigeration cycle in which a high-pressure side refrigerant pressure is equal to or higher than the critical pressure of the refrigerant.

The configuration of the heating unit is not limited to that disclosed in the above-described embodiment. For example, a three way valve and a high temperature side radiator similar to the three way valve 53 and the low temperature side radiator 54 of the low temperature side thermal medium circuit 50 may be added to the high temperature side thermal medium circuit 40 described in the first embodiment, and excess heat may be dissipated to the outside air. Further, in a vehicle including an internal combustion engine (engine) such as a hybrid vehicle, an engine cooling water may be circulated in the high temperature side thermal medium circuit 40.

The configuration of the cooling unit is not limited to the one disclosed in the above-described embodiment. For example, as the cooling unit, a thermosiphon, which has a condensing unit provided by the chiller 19 in the low temperature side thermal medium circuit 50 described in the first embodiment and an evaporating unit provided by the cooling heat exchange unit 52, may be adopted. According to this, the low temperature side thermal medium pump 51 can be eliminated.

The thermosiphon has an evaporating unit that evaporates a refrigerant and a condensing unit that condenses the refrigerant, and is configured by connecting the evaporating unit and the condensing unit in a closed loop (that is, in a circuit shape). Then, it is a thermal transporting circuit to transport thermal energy and the refrigerant by naturally circulating the refrigerant due to a gravitational function, by creating a specific gravity difference on the refrigerant within the circuit due to a temperature difference between a temperature of the refrigerant in the evaporating unit and a temperature of the refrigerant in the condensing unit.

Further, in the above-described embodiment, the example in which the cooling object cooled by the cooling unit is the battery 80 has been described, but the cooling object is not limited to this. It may be an inverter that converts direct current and alternating current, a charger that charges the battery 80 with electric power, and an electric device that may generate heat during operation such as a motor generator that outputs driving power for traveling by being supplied with electric power and generates regenerative electric power during deceleration or the like.

In each of the above-described embodiments, the refrigeration cycle device 10 according to the present disclosure is applied to the vehicle air-conditioner 1, but the application of the refrigeration cycle device 10 is not limited to this. For example, it may be applied to such as an air-conditioner with a server cooling function for appropriately adjusting a temperature of a computer server and air-conditioning a room.

In the above-described embodiment, in the heating and cooling mode (8) and the cooling mode (11), the target low temperature side thermal medium temperature TWLO is determined to be the second fixed value TWLO2 stored in advance in the control unit 60, but in the heating and cooling mode (8) and the cooling mode (11), the target low temperature side thermal medium temperature TWLO may be determined to be a temperature lower than the outside air temperature by a predetermined temperature.

As a result, it is possible to surely dissipate heat to the outside air at the outdoor heat exchanger 16 in the heating and cooling mode (8) and the cooling mode (11).

Compare to the disclosure, JP2012-225637A describes a conventional vehicle refrigeration cycle device capable of air-conditioning, heating, and dehumidifying and heating a vehicle compartment.

At a time of air-conditioning, heat is absorbed from air blown into a vehicle compartment to a refrigerant at an indoor evaporator, and heat is dissipated from the refrigerant to outside air at an outdoor heat exchanger. Accordingly, the air blown into the vehicle compartment is cooled. At the time of heating, heat is absorbed from the outside air to the refrigerant at the outdoor heat exchanger, and heat is dissipated from the refrigerant to the air blown into the vehicle compartment at a radiator. Accordingly, the air blown into the vehicle compartment is heated. During dehumidifying and heating, heat is absorbed from the air blown into the vehicle compartment to the refrigerant at the indoor evaporator, heat is absorbed from the outside air to the refrigerant at the outdoor heat exchanger, and heat is dissipated at the radiator from the refrigerant to the air of which heat is absorbed at the indoor evaporator. As a result, the air blown into the vehicle interior is dehumidified and then heated.

In hybrid vehicles or electric vehicles, a battery supplying driving power may need to be cooled. The inventors considered cooling the battery by adding a battery cooling evaporator to the refrigeration cycle device. Specifically, in a flow of the refrigerant, it is being considered to cool the air and cool the battery by arranging a battery cooling evaporator in parallel with the evaporator for cooling the air.

However, according to a detailed study by the inventors, in this study example, it is found that a power consumption of the vehicle refrigeration cycle device (specifically, a power consumption of the compressor) significantly varies in accordance with what a temperature is set as a target temperature of the battery cooling evaporator (see FIG. 24 described later.) Moreover, it is found that a power consumption of the vehicle refrigeration cycle device (specifically, a power consumption of the compressor) differs among cases. For example, the case includes a case, where heat is absorbed to the refrigerant at the battery cooling evaporator and at least one heat exchanger among the outdoor heat exchanger and the indoor heat exchanger. The case includes a case where heat is absorbed to the refrigerant at only the battery cooling evaporator. See FIGS. 25 to 26 described.

Further, this problem also occurs in a refrigeration cycle device capable of switching between a case where heat is absorbed to the refrigerant at a plurality of evaporators and a case where heat is absorbed to the refrigerant at only one evaporator, in a similar manner. In view of the above points, it is an object of the present disclosure to save power in a refrigeration cycle device provided with a plurality of evaporators.

Although the present disclosure has been described in accordance with the embodiments, it is understood that the present disclosure is not limited to the embodiments and structures disclosed therein. The present disclosure also includes various modifications and variations within an equivalent range. In addition, while the various combinations and configurations, which are preferred, other combinations and configurations, including more, less or only a single element, are also within the spirit and scope of the present disclosure.

What is claimed is:

1. A refrigerant cycle device, comprising:
a compressor which compresses and discharges a refrigerant;
a radiator which dissipates heat from the refrigerant discharged from the compressor;
a first evaporator for evaporating the refrigerant;
a second evaporator which evaporates the refrigerant by absorbing heat from a thermal medium circulating between a heat absorb object or from the heat absorb object;
a first orifice unit capable of changing a flow amount of the refrigerant flowing into the first evaporator;
a second orifice unit capable of changing a flow amount of the refrigerant flowing into the second evaporator; and
a control unit, including at least one hardware processor circuit, which controls operation of the compressor and the second orifice unit so that a temperature relating to a temperature of the second evaporator approaches a target temperature, wherein
the control unit is configured to switch:
a first mode in which the first orifice unit and the second orifice unit are controlled so that the refrigerant does not evaporate in the first evaporator and the refrigerant evaporates in the second evaporator; and
a second mode in which the first orifice unit and the second orifice unit are controlled so that the refrigerant evaporates in both the first evaporator and the second evaporator, and wherein
the control unit sets the target temperature in the first mode higher than that in the second mode.

2. The refrigerant cycle device claimed in claim 1, wherein
the first evaporator includes:
an outdoor heat exchanger which performs heat exchange between the refrigerant flowing out of the radiator and the outside air; and
an indoor evaporator which evaporates the refrigerant flowing out from the outdoor heat exchanger, and wherein
the first orifice unit includes:
an outdoor heat exchanger orifice unit capable of changing a flow amount of the refrigerant flowing into the outdoor heat exchanger; and an indoor evaporator orifice unit capable of changing a flow amount of the refrigerant flowing into the indoor evaporator, and wherein
the heat absorb object is a battery, and wherein the refrigerant cycle device further comprises:
a first refrigerant passage in which the outdoor heat exchanger orifice unit is arranged, and which guides the refrigerant flowing out from the radiator to an inlet side of the outdoor heat exchanger;
a second refrigerant passage which guides the refrigerant flowing out from the outdoor heat exchanger to a suction side of the compressor;
a second refrigerant passage on-off unit arranged in the second refrigerant passage and opening or closing the second refrigerant passage;
a third refrigerant passage in which the indoor evaporator orifice unit is arranged, and which guides the refrigerant flowing out from the outdoor heat exchanger to the suction side of the compressor via the indoor evaporator;
a bypass passage which guides the refrigerant flowing between the radiator and the outdoor heat exchanger orifice unit to between the outdoor heat exchanger in the third refrigerant passage and the second orifice unit;
a bypass on-off unit arranged in the bypass passage and opening or closing the bypass passage;
a battery cooling passage in which the second orifice unit is arranged, and which guides the refrigerant flowing between the outdoor heat exchanger and the first orifice unit to between the indoor evaporator in the third refrigerant passage and the suction side of the compressor via the second evaporator, wherein
the control unit controls:
the outdoor heat exchanger orifice unit, the indoor evaporator orifice unit, the second orifice unit, the second refrigerant passage on-off unit, and the bypass on-off unit, so that the refrigerant dissipates heat on at least one of the radiator and the outdoor heat exchanger, the refrigerant evaporates at the second evaporator, and the refrigerant does not evaporate at the indoor evaporator in the first mode; and
the outdoor heat exchanger orifice unit, the indoor evaporator orifice unit, the second orifice unit, the second refrigerant passage on-off unit, and the bypass on-off unit, so that the refrigerant evaporates at the second evaporator, and the refrigerant evaporates on at least one of the outdoor heat exchanger and the indoor evaporator in the second mode.

3. The refrigerant cycle device claimed in claim 2, wherein
the first mode includes:
a heating and cooling mode in which the refrigerant dissipates heat in the radiator and the outdoor heat exchanger, the refrigerant evaporates in the second evaporator, and the refrigerant does not flow into the indoor evaporator; and
a cooling mode in which the refrigerant does not dissipate in the radiator, the refrigerant dissipates in the outdoor heat exchanger, the refrigerant evaporates in the second evaporator, and the refrigerant does not flow into the indoor evaporator.

4. The refrigerant cycle device claimed in claim 1, wherein
the second evaporator evaporates the refrigerant by absorbing heat from the thermal medium, and wherein the refrigerant cycle device further comprises:
a cooling heat exchange unit which cools the heat absorb object by the thermal medium of which heat is absorbed at the second evaporator, wherein
the temperature relating to the temperature of the second evaporator is a temperature of the thermal medium of which heat is absorbed at the second evaporator.

5. The refrigerant cycle device claimed in claim 1, wherein
the target temperature is set to a temperature lower than the outside air temperature in the first mode.

6. The refrigerant cycle device claimed in claim 1, wherein
the control unit further controls, in the first mode,
the compressor based on a deviation between the target temperature and the temperature relating to a temperature of the second evaporator,
the control unit further controls, in the second mode,
the second orifice unit to open when the temperature relating to a temperature of the second evaporator is higher than the target temperature,
the second orifice unit to close when the temperature relating to a temperature of the second evaporator is lower than the target temperature, and
the compressor based on a deviation between the target temperature and the temperature relating to a temperature of the second evaporator.
